(19) United States
(12) Patent Application Publication
(10) Pub. No.: US 2025/0340781 A1
(43) Pub. Date: Nov. 6, 2025

(54) POLYMERIZABLE LIQUID CRYSTAL COMPOSITION, OPTICALLY ANISOTROPIC FILM, OPTICAL FILM, POLARIZING PLATE, IMAGE DISPLAY APPARATUS, AND METHOD FOR PRODUCING POLYMERIZABLE LIQUID CRYSTAL COMPOSITION

(71) Applicant: FUJIFILM Corporation, Tokyo (JP)

(72) Inventor: Ryoji GOTO, Kanagawa (JP)

(73) Assignee: FUJIFILM Corporation, Tokyo (JP)

(21) Appl. No.: 19/271,140

(22) Filed: Jul. 16, 2025

Related U.S. Application Data
(63) Continuation of application No. PCT/JP2024/004484, filed on Feb. 9, 2024.

(30) Foreign Application Priority Data
Feb. 22, 2023 (JP) 2023-026490

(51) Int. Cl. C09K 19/38; C08F 222/24; G02B 5/30

(52) U.S. Cl. CPC C09K 19/3861; C08F 222/24; G02B 5/3016; C08F 2800/20

(57) ABSTRACT

A polymerizable liquid crystal composition having excellent solubility and low precipitation from a solution, an optically anisotropic film, an optical film, a polarizing plate, an image display apparatus, and a method for producing a polymerizable liquid crystal composition. The polymerizable liquid crystal composition of the present invention contains polymerizable liquid crystal compounds P1: W1-C(═O)—O—Ar1-O—C(═O)—W1 (Formula (1)), P2: W1-C(═O)—O—Ar1-O—C(═O)—W2 (Formula (2)), P4: W2-C(═O)—O—Ar2-O—C(═O)—W2 (Formula (4)), and P5: W2-C(═O)—O—Ar2-O—C(═O)—W1 (Formula (5)).

### CROSS-REFERENCE TO RELATED APPLICATIONS

This application is a Continuation of PCT International Application No. PCT/JP2024/004484 filed on Feb. 9, 2024, which was published under PCT Article 21(2) in Japanese, and which claims priority under 35 U.S.C. § 119(a) to Japanese Patent Application No. 2023-026490 filed on Feb. 22, 2023. The above applications are hereby expressly incorporated by reference, in their entirety, into the present application.

### BACKGROUND OF THE INVENTION

### 1. Field of the Invention

The present invention relates to a polymerizable liquid crystal composition, an optically anisotropic film, an optical film, a polarizing plate, an image display apparatus, and a method for producing a polymerizable liquid crystal composition.

### 2. Description of the Related Art

A polymerizable liquid crystal compound exhibiting a reverse wavelength dispersion property can accurately convert ray wavelengths over a wide wavelength range and reduce a thickness of a retardation film due to its high birefringence index, and the polymerizable liquid crystal compound has been actively studied.

In addition, for the polymerizable liquid crystal compound exhibiting a reverse wavelength dispersion property, T-type molecular design guidelines have generally been adopted, and it has been required to decrease a wavelength of a major axis of a molecule and increase a wavelength of a minor axis positioned at a center of the molecule.

Therefore, it has been known that an aromatic skeleton having a high absorbance in an UV-A range (250 to 400 nm) is used as a skeleton of the minor axis positioned at the center of the molecule (hereinafter, also referred to as “core portion”), and a cycloalkylene skeleton having no absorption wavelength in the visible range and the UV-A range (250 to 400 nm) is used as a rigid portion (hereinafter, also referred to as “side chain portion”) forming the major axis of the molecule (for example, see JP2010-031223A, WO2014/010325A, and JP2016-081035A).

### SUMMARY OF THE INVENTION

As a result of studying JP2010-031223A, WO2014/010325A, and JP2016-081035A, the present inventors have found that, depending on the type of the polymerizable compound, solubility of the polymerizable liquid crystal composition may be deteriorated, and precipitates may be generated from a solution of the polymerizable liquid crystal composition.

Therefore, an object of the present invention is to provide a polymerizable liquid crystal composition having excellent solubility and low precipitation from a solution, an optically anisotropic film, an optical film, a polarizing plate, an image display apparatus, and a method for producing a polymerizable liquid crystal composition.

As a result of intensive studies to achieve the above-described object, the present inventors have found that a polymerizable liquid crystal composition obtained by formulating four types of predetermined polymerizable liquid crystal compounds in which at least one of a core portion or a side chain portion is different from each other has excellent solubility and low precipitation from a solution, thereby completing the present invention.

That is, the present inventors have found that the above-described object can be achieved by employing the following configurations.

[1]A polymerizable liquid crystal composition comprising:
polymerizable liquid crystal compounds P1, P2, P4, and P5 respectively represented by Formulae (1), (2), (4), and (5) described later.

[2] The polymerizable liquid crystal composition according to [1], further comprising:
polymerizable liquid crystal compounds P3 and P6 respectively represented by Formulae (3) and (6) described later.

[3] The polymerizable liquid crystal composition according to [2],
in which, in a case where area percentages of each of the polymerizable liquid crystal compounds P1 to P6 are measured at a measurement wavelength of 254 nm with a high-performance liquid chromatograph, a larger one of the area percentages of the polymerizable liquid crystal compounds P1 and P3 is defined as C1 and a smaller one thereof is defined as C3, a larger one of the area percentages of the polymerizable liquid crystal compounds P4 and P6 is defined as C4 and a smaller one thereof is defined as C6, and the area percentages of the polymerizable liquid crystal compounds P2 and P5 are each defined as C2 and C5, expressions (A), (B), (C), (D), and (E) described later are satisfied.

[4] The polymerizable liquid crystal composition according to any one of [1] to [3],
in which the polymerizable liquid crystal composition has smectic liquid crystallinity.

[5] An optically anisotropic film obtained by fixing an alignment state of the polymerizable liquid crystal composition according to any one of [1] to [4].

[6] The optically anisotropic film according to [5],
in which an expression (F) described later is satisfied.

[7] An optical film comprising:
the optically anisotropic film according to [5] or [6].

[8]A polarizing plate comprising:
the optical film according to [7]; and a polarizer.

[9] An image display apparatus comprising:
the optical film according to [7] or the polarizing plate according to [8].

[10]A method for producing a polymerizable liquid crystal composition, comprising:
dissolving polymerizable liquid crystal compounds P1 and P3 respectively represented by Formulae (1) and (3) described later in a solvent and performing a reaction to obtain a polymerizable liquid crystal composition containing polymerizable liquid crystal compounds P1 to P3 respectively represented by Formulae (1) to (3) described later and the solvent.

[11]A method for producing a polymerizable liquid crystal composition, comprising:
dissolving polymerizable liquid crystal compounds P1 and P4 respectively represented by Formulae (1) and (4) described later in a solvent and performing a reaction to obtain a polymerizable liquid crystal composition containing polymerizable liquid crystal compounds P1, P2, P4, and P5 respectively represented by Formulae (1), (2), (4), and (5) described later and the solvent.

[12] The method for producing a polymerizable liquid crystal composition according to [11],
in which the polymerizable liquid crystal composition further contains polymerizable liquid crystal compounds P3 and P6 respectively represented by Formulae (3) and (6) described later.

[13] The method for producing a polymerizable liquid crystal composition according to any one of [10] to [12],
in which a basic compound is added before the reaction.

[14] The method for producing a polymerizable liquid crystal composition according to [13],
in which the basic compound is removed after the reaction.

According to the present invention, it is possible to provide a polymerizable liquid crystal composition having excellent solubility and low precipitation from a solution, an optically anisotropic film, an optical film, a polarizing plate, an image display apparatus, and a method for producing a polymerizable liquid crystal composition.

### BRIEF DESCRIPTION OF THE DRAWINGS

FIG. 1 is a schematic cross-sectional view showing an example of an optical film.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Any numerical range expressed using “to” in the present specification refers to a range including the numerical values before and after the “to” as a lower limit value and an upper limit value, respectively.

In addition, in a range of numerical values described in stages in the present specification, the upper limit value or the lower limit value described in a certain range of numerical values may be replaced with an upper limit value or a lower limit value of the range of numerical values described in other stages. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof. Here, in a case where two or more types of substances are used in combination for each component, the content of the component refers to a total content of the substances used in combination unless otherwise specified.

In addition, in this specification, “(meth)acrylic” is a notation representing “acrylic” or “methacrylic”.

In addition, in the present specification, a bonding direction of a divalent group (for example, —CO—O—) described is not particularly limited except for a case where the bonding position is specified; and for example, in a case where L² in an “L¹-L²-L³” bond is —O—CO—, and a bonding position on the L¹ side is represented by *1 and a bonding position on the L³ side is represented by *2, L² may be *1-O—CO—*2 or *1-CO—O—*2.

In the present specification, Re(λ) and Rth(λ) respectively represent an in-plane retardation at a wavelength λ and a thickness-direction retardation at a wavelength λ. Unless otherwise specified, the wavelength λ refers to 550 nm.

In addition, in the present specification, Re(λ) and Rth(λ) are values measured at a wavelength λ using AxoScan OPMF-1 (manufactured by Optoscience. Inc.).

Specifically, by inputting an average refractive index ((nx+ny+nz)/3) and a film thickness (d(μm)) in AxoScan OPMF-1, a slow axis direction (°), Re(λ)=R0(λ), and Rth(λ)=((nx+ny)/2−nz)×d are calculated.

In addition, R0(λ) is expressed in a numerical value calculated with AxoScan OPMF-1, and means Re(λ).

### [Polymerizable Liquid Crystal Composition]

The polymerizable liquid crystal composition according to the embodiment of the present invention is a polymerizable liquid crystal composition containing polymerizable liquid crystal compounds P1, P2, P4, and P5 respectively represented by Formulae (1), (2), (4), and (5); and it is preferable to be a polymerizable liquid crystal composition containing polymerizable liquid crystal compounds P1 to P6 respectively represented by Formulae (1) to (6).

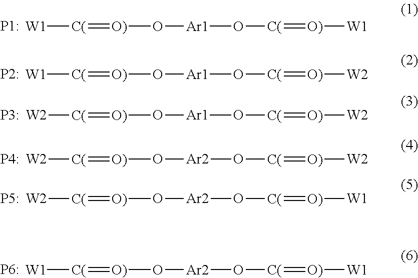

In Formulae (1) to (6), W1's represent a monovalent group represented by Formula (7) described later, each of which has the same ClogP value, and W2's represent a monovalent group represented by Formula (8) described later, each of which has the same ClogP value. However, the ClogP value of W1's is different from the ClogP value of W2's.

In addition, Ar1's represent a divalent aromatic ring, each of which has the same ClogP value, Ar2's represent a divalent aromatic ring, each of which has the same ClogP value, and at least one of Ar1 or Ar2 represents any aromatic ring selected from the group consisting of groups represented by Formulae (Ar-1) to (Ar-7) described later. However, the ClogP value of Ar1's is larger than the ClogP value of Ar2's.

Here, the ClogP value is a value of the common logarithm log P of a partition coefficient P to 1-octanol and water obtained by calculation. A known method or software can be used for calculating the ClogP value, but in the present invention, unless otherwise specified, a ClogP program incorporated in ChemDraw 20.1 of PerkinElmer Inc. is used.

In addition, regarding W1 in the formulae, “the same ClogP value” means that two W1's in Formula (1), one W1 in Formula (2), one W1 in Formula (5), and two W1's in Formula (6) all have a structure (that is, the same structure or structural isomers) in which the ClogP values are the same. W2, Ar1, and Ar2 in the formulae are interpreted likewise.

In addition, regarding W1 and W2 in the formulae, “the ClogP value of W1's is different from the ClogP value of W2's” means that W1's and W2's are structures in which the ClogP values are different from each other (that is, non-identical structures which do not correspond to structural isomers).

In addition, regarding Ar1 and Ar2 in the formulae, “the ClogP value of Ar1's is larger than the ClogP value of Ar2's” means that Ar1's and Ar2's are structures in which the ClogP values are different from each other, and the structure having a larger ClogP value is Ar1.

In the present invention, as described above, the polymerizable liquid crystal composition containing the polymerizable liquid crystal compounds P1, P2, P4, and P5 respectively represented by Formulae (1), (2), (4), and (5) has excellent solubility and low precipitation from a solution.

The reason why the effect is exhibited is not clear in detail, but the present inventors have presumed as follows.

That is, it is presumed that, since the structures of at least one of the core portion or the side chain portion are different from each other in each of the polymerizable liquid crystal compounds P1, P2, P4, and P5 respectively represented by Formulae (1), (2), (4), and (5), packing of molecules is inhibited, and as a result, the solubility of the polymerizable liquid crystal compound in an organic solvent is improved.

Hereinafter, the respective components of the polymerizable liquid crystal composition according to the embodiment of the present invention will be described in detail.

### [Polymerizable Liquid Crystal Compound]

As described above, the polymerizable liquid crystal composition according to the embodiment of the present invention contains polymerizable liquid crystal compounds P1, P2, P4, and P5 respectively represented by Formulae (1), (2), (4), and (5); and it is preferable to contain polymerizable liquid crystal compounds P1 to P6 respectively represented by Formulae (1) to (6).

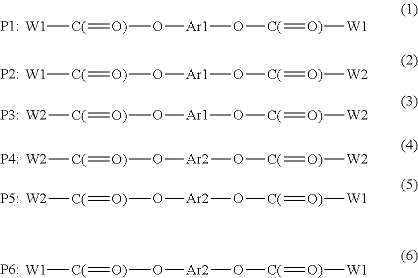

In Formulae (1) to (6), W1's represent a monovalent group represented by Formula (7), each of which has the same ClogP value, and W2's represent a monovalent group represented by Formula (8), each of which has the same ClogP value. However, the ClogP value of W1's is different from the ClogP value of W2's.

In addition, Ar1's represent a divalent aromatic ring, each of which has the same ClogP value, Ar2's represent a divalent aromatic ring, each of which has the same ClogP value, and at least one of Ar1 or Ar2 represents any aromatic ring selected from the group consisting of groups represented by Formulae (Ar-1) to (Ar-7) described later. However, the ClogP value of Ar1's is larger than the ClogP value of Ar2's.

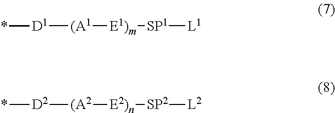

In Formulae (7) and (8), * represents a bonding position to C(═O).

In addition, m and n each independently represent an integer of 1 or more.

In addition, D¹, D², E¹, and E² each independently represent a single bond, —CO—, —O—, —S—, —C(═S)—, —CR¹R²—, —CR³═CR⁴—, —NR⁵—, or a divalent linking group consisting of a combination of two or more of these groups, where R¹ to R⁵ each independently represent a hydrogen atom, a fluorine atom, or an alkyl group having 1 to 4 carbon atoms. In a case where m is an integer of 2 or more, a plurality of E¹'s may be the same or different from each other, and in a case where n is an integer of 2 or more, a plurality of E²'s may be the same or different from each other.

A¹ and A² each independently represent an aromatic ring having 6 or more carbon atoms, which may have a substituent, or a cycloalkane ring having 6 or more carbon atoms, which may have a substituent. In a case where m is an integer of 2 or more, a plurality of A¹'s may be the same or different from each other, and in a case where n is an integer of 2 or more, a plurality of A²'s may be the same or different from each other.

SP¹ and SP² each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent.

L¹ and L² each independently represent a monovalent organic group, where at least one of L¹ or L² represents a polymerizable group. Here, in a case where Ar1 or Ar2 in Formulae (1), (2), (4), and (5) is an aromatic ring represented by Formula (Ar-3) described later, at least one of L¹ or L², or L³ or L⁴ in Formula (Ar-3) described later represents a polymerizable group.

In Formulae (7) and (8), m and n each independently represent an integer of 1 or more, preferably 1 to 3, more preferably 1 or 2, and still more preferably 2.

In Formulae (7) and (8), examples of the divalent linking group represented by one aspect of D¹, D², E¹, and E² include —CO—O—, —C(═S)O—, —CR¹R²—, —CR¹R²—CR¹R²—, —O—CR¹R²—, —CR¹R²—, —O—CR¹R²—, —CO—O—CR¹R²—, —O—CO—CR¹R²—, —CR¹R²—O—CO—CR¹R²—, —CR¹R²—CO—O—CR¹R²—, —NR⁵—CR¹R²—, and —CO—NR⁵—. R¹, R², and R⁵ each independently represent a hydrogen atom, a fluorine atom, or an alkyl group having 1 to 4 carbon atoms.

D¹ and D² are preferably a single bond.

E¹ and E² are preferably —O—, —CO—O—, or —CO—NR⁵—, and more preferably —CO—O—.

In Formulae (7) and (8), examples of the aromatic ring having 6 or more carbon atoms, represented by one aspect of A¹ and A², include aromatic hydrocarbon rings such as a benzene ring, a naphthalene ring, an anthracene ring, and a phenanthroline ring; and aromatic heterocyclic rings such as a furan ring, a pyrrole ring, a thiophene ring, a pyridine ring, a thiazole ring, and a benzothiazole ring. Among these, a benzene ring (for example, a 1,4-phenyl group) is preferable.

In addition, in Formulae (4) and (5), examples of the cycloalkane ring having 6 or more carbon atoms, represented by one aspect of A¹ and A², include a cyclohexane ring, a cyclopeptane ring, a cyclooctane ring, a cyclododecane ring, and a cyclodocosane ring. Among those, a cyclohexane ring (for example, a 1,4-cyclohexylene group) is preferable, and a trans-1,4-cyclohexylene group is more preferable.

In addition, in Formulae (7) and (8), examples of the substituent which may be contained in the aromatic ring having 6 or more carbon atoms or the cycloalkane ring having 6 or more carbon atoms, for A¹ and A², include an alkyl group, an alkoxy group, an alkylcarbonyl group, an alkoxycarbonyl group, an alkylcarbonyloxy group, an alkylamino group, a dialkylamino group, an alkylamide group, an alkenyl group, an alkynyl group, a halogen atom, a cyano group, a nitro group, an alkylthiol group, and an N-alkylcarbamate group; and among these, an alkyl group, an alkoxy group, an alkoxycarbonyl group, an alkylcarbonyloxy group, or a halogen atom is preferable.

The alkyl group is preferably a linear, branched, or cyclic alkyl group having 1 to 18 carbon atoms, more preferably an alkyl group having 1 to 8 carbon atoms (for example, a methyl group, an ethyl group, a propyl group, an isopropyl group, an n-butyl group, an isobutyl group, an sec-butyl group, a t-butyl group, a cyclohexyl group, or the like), still more preferably an alkyl group having 1 to 4 carbon atoms, and particularly preferably a methyl group or an ethyl group.

The alkoxy group is preferably an alkoxy group having 1 to 18 carbon atoms, more preferably an alkoxy group having 1 to 8 carbon atoms (for example, a methoxy group, an ethoxy group, an n-butoxy group, a methoxyethoxy group, or the like), still more preferably an alkoxy group having 1 to 4 carbon atoms, and particularly preferably a methoxy group or an ethoxy group.

Examples of the alkoxycarbonyl group include a group in which an oxycarbonyl group (—O—CO— group) is bonded to the alkyl group exemplified above; and among these, a methoxycarbonyl group, an ethoxycarbonyl group, an n-propoxycarbonyl group, or an isopropoxycarbonyl group is preferable, a methoxycarbonyl group is more preferable.

Examples of the alkylcarbonyloxy group include a group in which a carbonyloxy group (—CO—O— group) is bonded to the alkyl group exemplified above; and among these, a methylcarbonyloxy group, an ethylcarbonyloxy group, an n-propylcarbonyloxy group, or an isopropylcarbonyloxy group is preferable, and a methylcarbonyloxy group is more preferable.

Examples of the halogen atom include a fluorine atom, a chlorine atom, a bromine atom, and an iodine atom; and among these, a fluorine atom or a chlorine atom is preferable.

In Formulae (7) and (8), the alkylene group having 1 to 20 carbon atoms, represented by one aspect of SP¹ and SP², may be linear or branched, and is preferably an alkylene group having 1 to 12 carbon atoms. Suitable examples thereof include a methylene group, an ethylene group, a propylene group, a butylene group, a pentylene group, a hexylene group, a methylhexylene group, and a heptylene group.

In addition, the alkenylene group having 2 to 20 carbon atoms, represented by one aspect of SP¹ and SP², may be linear or branched, and is preferably an alkenylene group having 2 to 20 carbon atoms. Suitable examples thereof include an ethenylene group, a propenylene group, and a butenylene group.

In addition, the alkynylene group having 2 to 20 carbon atoms, represented by one aspect of SP¹ and SP², may be linear or branched, and suitable examples thereof include an ethynylene group.

As described above, SP¹ and SP² may be a divalent linking group in which one or more of —CH₂-'s constituting the alkylene group, the alkenylene group, and the alkynylene group are substituted with —O—, —S—, —NH—, —N(Q)-, or —CO—; and examples of the substituent represented by Q include the same substituents as the substituents described in A¹ and A² in Formulae (7) and (8) above.

In Formulae (7) and (8), examples of the monovalent organic group represented by L¹ and L² include an alkyl group, an aryl group, and a heteroaryl group. The alkyl group may be linear, branched, or cyclic, but is preferably linear. The number of carbon atoms of the alkyl group is preferably 1 to 30, more preferably 1 to 20, and still more preferably 1 to 10. In addition, the aryl group may be monocyclic or polycyclic, but is preferably monocyclic. The number of carbon atoms in the aryl group is preferably 6 to 25 and more preferably 6 to 10. In addition, the heteroaryl group may be monocyclic or polycyclic. The number of heteroatoms constituting the heteroaryl group is preferably 1 to 3. The heteroatom constituting the heteroaryl group is preferably a nitrogen atom, a sulfur atom, or an oxygen atom. The number of carbon atoms in the heteroaryl group is preferably 6 to 18 and more preferably 6 to 12. In addition, the alkyl group, the aryl group, and the heteroaryl group may be unsubstituted or may have a substituent. Examples of the substituent include the same substituents as those described for A¹ and A² in Formulae (7) and (8) above.

In Formulae (7) and (8), the polymerizable group represented by at least one of L¹ or L² is not particularly limited, but is preferably a polymerizable group capable of radical polymerization or cationic polymerization.

A known radically polymerizable group can be used as the radically polymerizable group, and suitable examples thereof include an acryloyloxy group or a methacryloyloxy group. In this case, it is known that the acryloyloxy group generally has a high polymerization rate, and from the viewpoint of improving productivity, the acryloyloxy group is preferable. However, the methacryloyloxy group can also be used as the polymerizable group.

A known cationically polymerizable group can be used as the cationically polymerizable group, and specific examples thereof include an alicyclic ether group, a cyclic acetal group, a cyclic lactone group, a cyclic thioether group, a spiro orthoester group, and a vinyloxy group. Among these, an alicyclic ether group or a vinyloxy group is suitable, and an epoxy group, an oxetanyl group, or a vinyloxy group is particularly preferable.

Examples of particularly preferred polymerizable group include a polymerizable group represented by any one of Formulae (P-1) to (P-20).

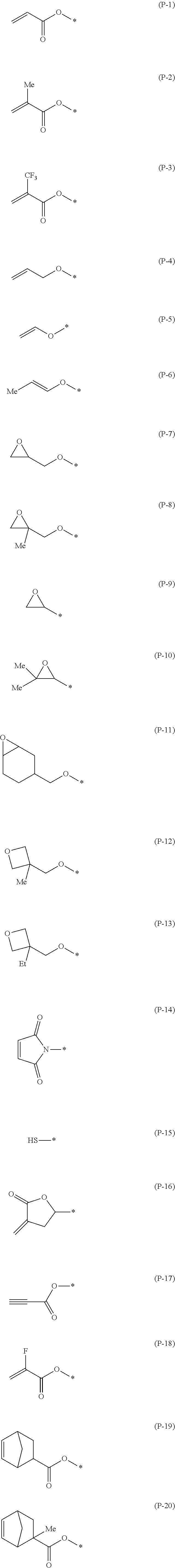

On the other hand, in Formulae (1) to (6), examples of the divalent aromatic ring represented by Ar1 and Ar2 include an aromatic ring having 6 or more carbon atoms, and specific examples thereof include the same ones as those described in A¹ and A² in Formulae (7) and (8) above.

In addition, at least one of Ar1 or Ar2 represents any aromatic ring selected from the group consisting of groups represented by Formulae (Ar-1) to (Ar-7). In Formulae (Ar-1) to (Ar-7), * represents a bonding position to an oxygen atom.

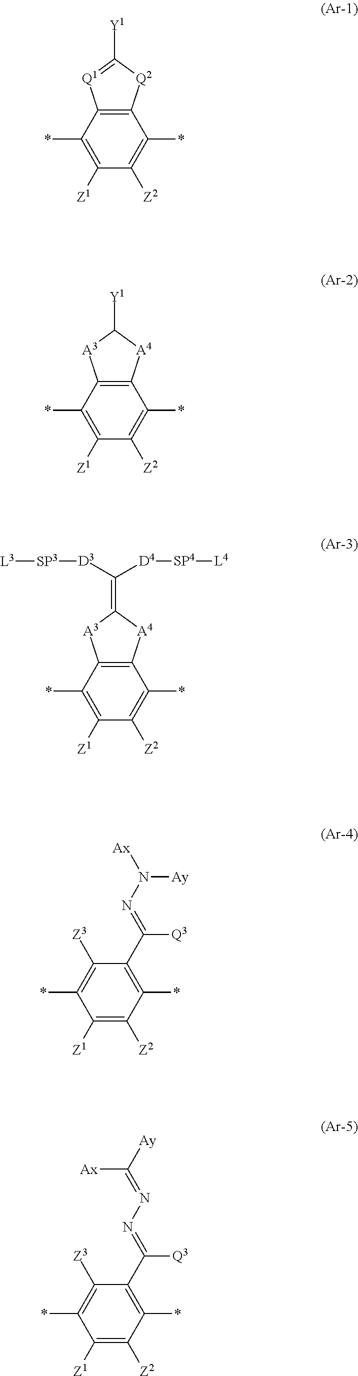

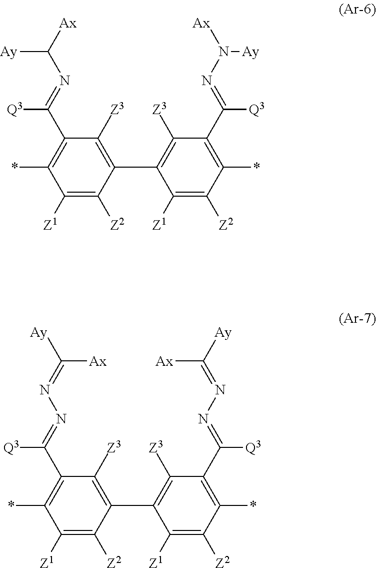

In Formula (Ar-1), Q¹ represents N or CH, Q² represents —S—, —O—, or —N(R⁶)—, R⁶ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, each of which may have a substituent.

Specific examples of the alkyl group having 1 to 6 carbon atoms, represented by one aspect of R⁶, include a methyl group, an ethyl group, a propyl group, an isopropyl group, an n-butyl group, an isobutyl group, a sec-butyl group, a tert-butyl group, an n-pentyl group, and an n-hexyl group.

Examples of the aromatic hydrocarbon group having 6 to 12 carbon atoms, represented by one aspect of Y¹, include aryl groups such as a phenyl group, a 2,6-diethylphenyl group, and a naphthyl group.

Examples of the aromatic heterocyclic group having 3 to 12 carbon atoms, represented by one aspect of Y¹, include a heteroaryl group such as a thienyl group, a thiazolyl group, a furyl group, and a pyridyl group.

In addition, examples of the substituent which may be included in Y¹ include the same substituents as those described for A¹ and A² in Formulae (7) and (8) above.

In addition, in Formulae (Ar-1) to (Ar-7), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a monovalent aromatic heterocyclic group having 6 to 20 carbon atoms, a halogen atom, a cyano group, a nitro group, —OR⁷, —NR⁸R⁹, or —SR¹⁰, where R⁷ to R¹⁰ each independently represent a hydrogen atom or an alkyl group having 1 to 6 carbon atoms, and Z¹ and Z² may be bonded to each other to form an aromatic ring.

As the monovalent aliphatic hydrocarbon group having 1 to 20 carbon atoms, an alkyl group having 1 to 15 carbon atoms is preferable, an alkyl group having 1 to 8 carbon atoms is more preferable, and specifically, a methyl group, an ethyl group, an isopropyl group, a tert-pentyl group (1,1-dimethylpropyl group), a tert-butyl group, or 1,1-dimethyl-3,3-dimethyl-butyl group is still more preferable and a methyl group, an ethyl group, or a tert-butyl group is particularly preferable.

Examples of the monovalent alicyclic hydrocarbon group having 3 to 20 carbon atoms include monocyclic saturated hydrocarbon groups such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene group; and polycyclic saturated hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly, a phenyl group) is preferable.

Specific examples of the monovalent aromatic heterocyclic group having 6 to 20 carbon atoms include a 4-pyridyl group, a 2-furyl group, a 2-thienyl group, a 2-pyrimidinyl group, and a 2-benzothiazolyl group.

Examples of the halogen atom include a fluorine atom, a chlorine atom, a bromine atom, and an iodine atom, and among these, a fluorine atom, a chlorine atom, or a bromine atom is preferable.

On the other hand, specific examples of the alkyl group having 1 to 6 carbon atoms, represented by one aspect of R⁷ to R¹⁰, include a methyl group, an ethyl group, a propyl group, an isopropyl group, an n-butyl group, an isobutyl group, a sec-butyl group, a tert-butyl group, an n-pentyl group, and an n-hexyl group.

As described above, Z¹ and Z² may be bonded to each other to form an aromatic ring, and examples of a structure in a case where Z¹ and Z² in Formula (Ar-1) are bonded to each other to form an aromatic ring include a group represented by Formula (Ar-1a). In Formula (Ar-1a), * represents a bonding position to the oxygen atom in Formulae (1) to (6).

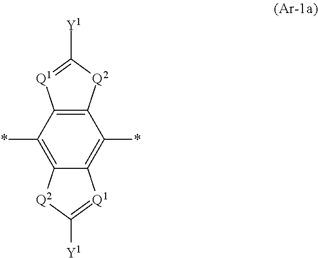

Here, in Formula (Ar-1a), examples of Q¹, Q², and Y¹ include the same as those described in Formula (Ar-1) above.

In addition, in Formulae (Ar-2) and (Ar-3), A³ and A⁴ each independently represent a group selected from the group consisting of —O—, —N(R¹¹)—, —S—, and —CO—, and R¹¹ represents a hydrogen atom or a substituent.

Examples of the substituent represented by R¹¹ include the same substituents as those described for A¹ and A² in Formulae (7) and (8) above.

In addition, in Formula (Ar-2), X represents a non-metal atom of Group 14 to Group 16. Here, a hydrogen atom or a substituent may be bonded to the non-metal atom.

In addition, examples of the non-metal atom of Groups 14 to 16, represented by X, include an oxygen atom, a sulfur atom, a nitrogen atom to which a hydrogen atom or a substituent is bonded [═N—R^{N1}, R^{N1} represents a hydrogen atom or a substituent], and a carbon atom to which a hydrogen atom or a substituent is bonded [═C—(R^{C1})₂, R^{C1} represents a hydrogen atom or a substituent].

Specific examples of the substituent include an alkyl group, an alkoxy group, an alkyl-substituted alkoxy group, a cyclic alkyl group, an aryl group (for example, a phenyl group, a naphthyl group, and the like), a cyano group, an amino group, a nitro group, an alkylcarbonyl group, a sulfo group, and a hydroxyl group.

In addition, in Formula (Ar-3), D³ and D⁴ each independently represent a single bond, —CO—, —O—, —S—, —C(═S)—, —CR¹R²—, —CR³=CR⁴—, —NR⁵—, or a divalent linking group consisting of a combination of two or more of these groups, where R¹ to R⁵ each independently represent a hydrogen atom, a fluorine atom, or an alkyl group having 1 to 4 carbon atoms.

Here, examples of the divalent linking group include the same as those described for D¹, D², E¹, and E² in Formulae (7) and (8) above.

In addition, in Formula (Ar-3), SP³ and SP⁴ each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent. Here, examples of the alkylene group, the alkenylene group, and the alkynylene group include the same ones as those described for SP¹ and SP² in Formulae (7) and (8) above. In addition, examples of the substituent include the same substituents as those described for A¹ and A² in Formulae (7) and (8) above.

In addition, in Formula (Ar-3), L³ and L⁴ each independently represent a monovalent organic group, and at least one of L³ or L⁴, or L¹ or L² in Formulae (7) and (8) above represents a polymerizable group.

Examples of the monovalent organic group include the same as those described for L¹ and L² in Formulae (7) and (8) above.

In addition, examples of the polymerizable group include the same as those described for L¹ and L² in Formulae (7) and (8) above.

In addition, in Formulae (Ar-4) to (Ar-7), Ax represents an organic group having 2 to 30 carbon atoms, which has at least one aromatic ring selected from the group consisting of an aromatic hydrocarbon ring and an aromatic heterocyclic ring.

In addition, in Formulae (Ar-4) to (Ar-7), Ay represents a hydrogen atom, an alkyl group having 1 to 12 carbon atoms, which may have a substituent, or an organic group having 2 to 30 carbon atoms which has at least one aromatic ring selected from the group consisting of an aromatic hydrocarbon ring and an aromatic heterocyclic ring.

Here, the aromatic rings in Ax and Ay may have a substituent, and Ax and Ay may be bonded to each other to form a ring.

In addition, Q³ represents a hydrogen atom or an alkyl group having 1 to 6 carbon atoms, which may have a substituent.

Examples of Ax and Ay include those described in paragraphs [0039] to [0095] of WO2014/010325A.

In addition, specific examples of the alkyl group having 1 to 20 carbon atoms, represented by Q³, include a methyl group, an ethyl group, a propyl group, an isopropyl group, an n-butyl group, an isobutyl group, a sec-butyl group, a tert-butyl group, an n-pentyl group, and an n-hexyl group; and examples of the substituent include the same substituents which may be included in G¹ and G² in Formula (5) described above.

Among the polymerizable liquid crystal compounds P1 to P6 respectively represented by Formulae (1) to (6), examples of the compounds respectively represented by Formulae (1), (3), (4), and (6) include compounds represented by General Formula (1) described in JP2010-084032A (particularly, compounds described in paragraphs [0067] to [0073]), compounds represented by General Formula (II) described in JP2016-053709A (particularly, compounds described in paragraphs [0036] to [0043]), and compounds represented by General Formula (1) described in JP2016-081035A (particularly, compounds described in paragraphs [0043] to [0055]).

In addition, among the polymerizable liquid crystal compounds P1 to P6 respectively represented by Formulae (1) to (6), suitable examples of the compounds respectively represented by Formulae (1), (3), (4), and (6) include compounds represented by Formulae (1) to (22), and specific examples thereof include compounds having side chain structures shown in Tables 1 to 3 below as K (side chain structure) in Formulae (1) to (22). Among the polymerizable liquid crystal compounds P1 to P6 respectively represented by Formulae (1) to (6), examples of the polymerizable liquid crystal compounds P2 and P5 respectively represented by Formulae (2) and (5) include compounds having different side chain structures shown in Tables 1 to 3 below as two K's (side chain structures) in Formulae (1) to (22).

In Tables 1 to 3 below, “*” shown in the side chain structure of K represents a bonding position to an aromatic ring.

In addition, in the side chain structures shown as 2-2 in Table 2 and 3-2 in Table 3, a group adjacent to each of the acryloyloxy group and the methacryloyl group represents a propylene group (a group in which a methyl group is replaced with an ethylene group), and represents a mixture of regioisomers in which the position of the methyl group is different.

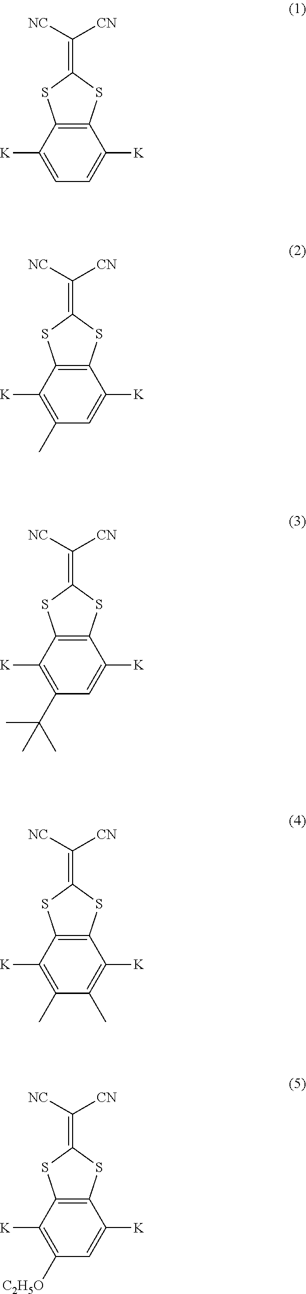

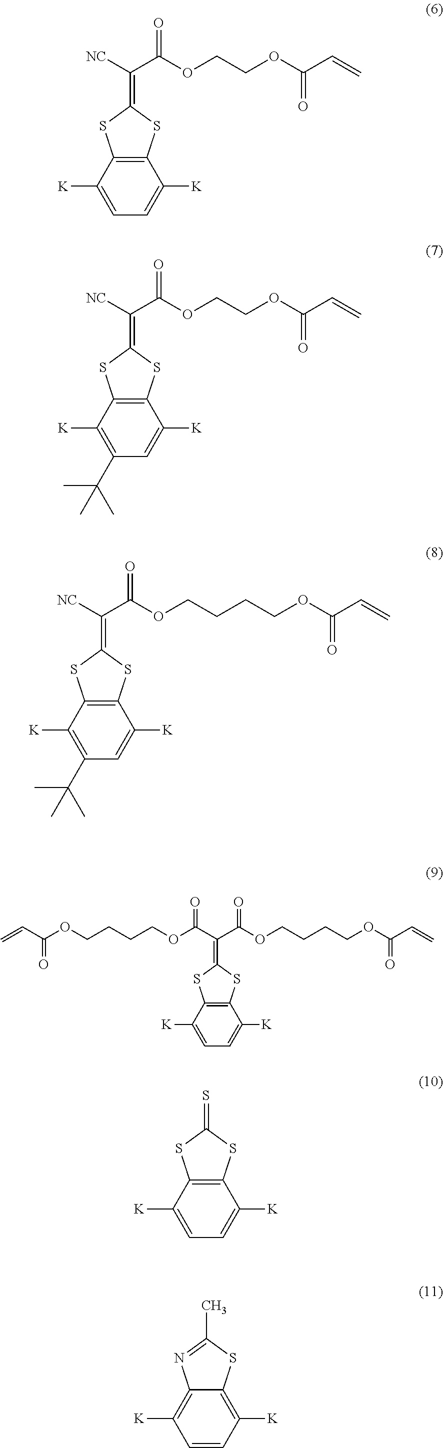

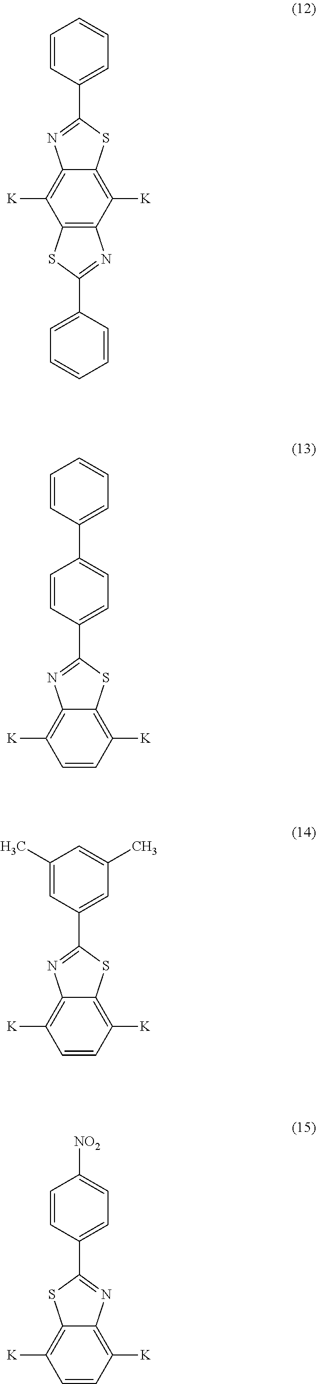

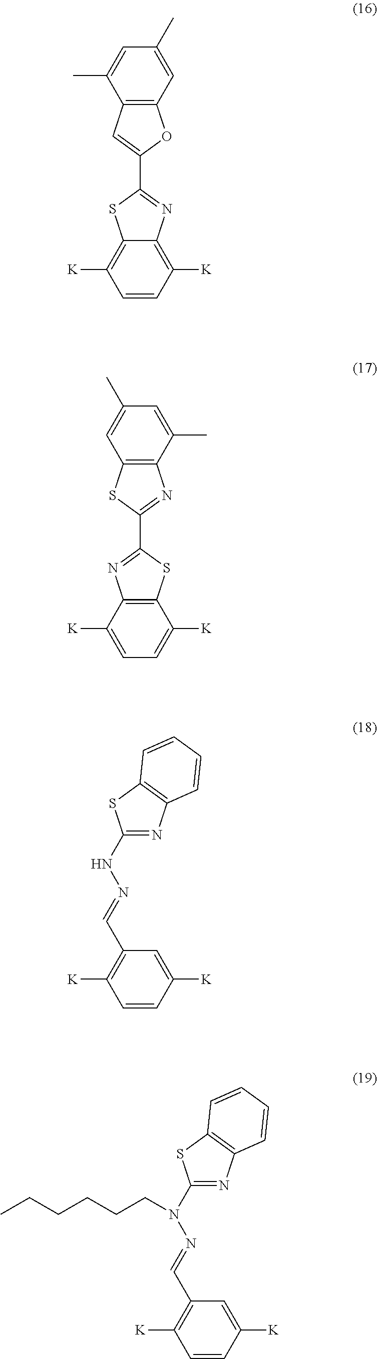

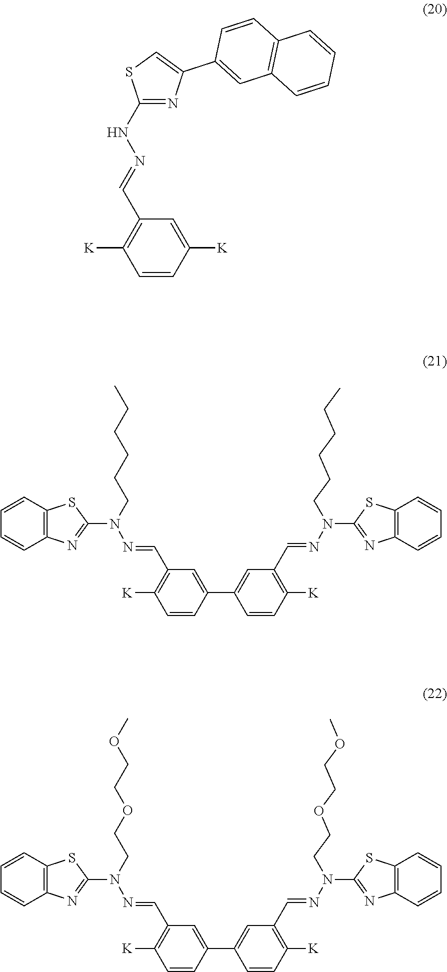

TABLE 1

| | K (side chain structure) |
|---|---|
| 1-1 | 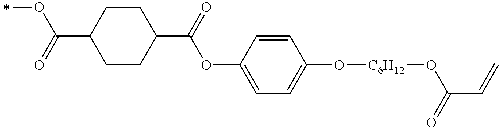 |
| 1-2 | 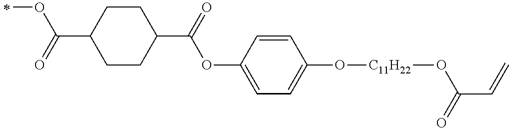 |
| 1-3 | 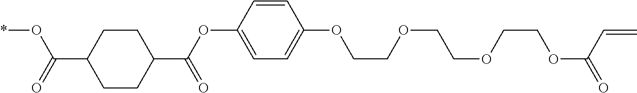 [SMILES: *OC(=O)C1CCC(C(=O)Oc2ccc(OCCOCCOCCOC(=O)C=C)cc2)CC1] |
| 1-4 | 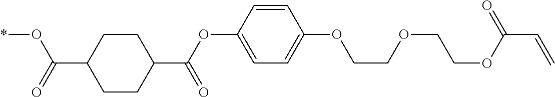 [SMILES: *OC(=O)C1CCC(C(=O)Oc2ccc(OCCOCCOC(=O)C=C)cc2)CC1] |
| 1-5 | 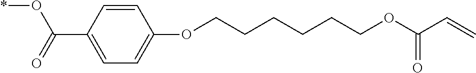 [SMILES: *OC(=O)c1ccc(OCCCCCCOC(=O)C=C)cc1] |
| 1-6 | 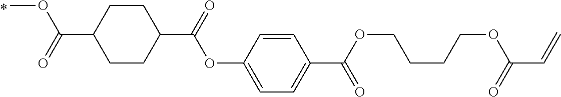 [SMILES: C=CC(=O)OCCCCOC(=O)c1ccc(OC(=O)C2CCC(C(=O)OC)CC2)cc1] |

TABLE 2

| | K (side chain structure) |
|---|---|
| 2-1 | 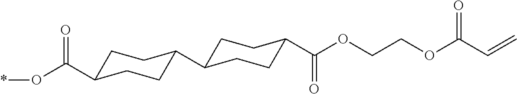 [SMILES: *OC(=O)C1CCC(C2CCC(C(=O)OCCOC(=O)C=C)CC2)CC1] |
| 2-2 | 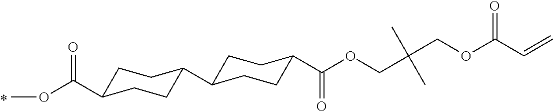 [SMILES: C=CC(=O)OCC(C)(C)COC(=O)C1CCC(C2CCC(C(=O)OC)CC2)CC1] |
| 2-3 | 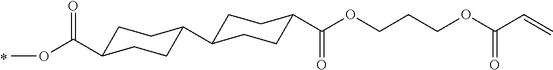 [SMILES: C=CC(=O)OCCCOC(=O)C1CCC(C2CCC(C(=O)OC)CC2)CC1] |
| 2-4 | 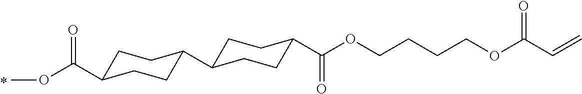 [SMILES: C=CC(=O)OCCCCOC(=O)C1CCC(C2CCC(C(=O)OC)CC2)CC1] |
| 2-5 | 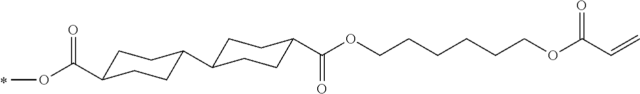 [SMILES: C=CC(=O)OCCCCCCOC(=O)C1CCC(C2CCC(C(=O)OC)CC2)CC1] |
| 2-6 | 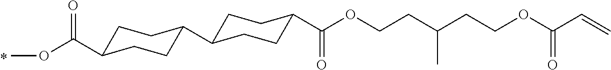 [SMILES: C=CC(=O)OCCC(C)CCOC(=O)C1CCC(C2CCC(C(=O)OC)CC2)CC1] |
| 2-7 | 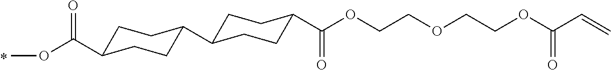 [SMILES: C=CC(=O)OCCOCCOC(=O)C1CCC(C2CCC(C(=O)OC)CC2)CC1] |
| 2-8 | 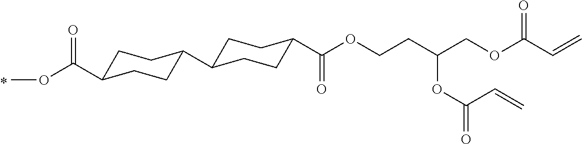 [SMILES: C=CC(=O)OCC(CCOC(=O)C1CCC(C2CCC(C(=O)OC)CC2)CC1)OC(=O)C=C] |
| 2-9 | 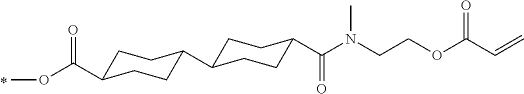 [SMILES: C=CC(=O)OCCN(C)C(=O)C1CCC(C2CCC(C(=O)OC)CC2)CC1] |
| 2-10 | 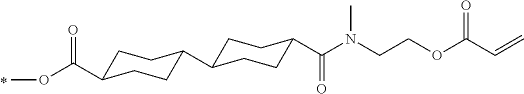 [SMILES: C=CC(=O)OCCN(C)C(=O)C1CCC(C2CCC(C(=O)OC)CC2)CC1] |
| 2-11 | 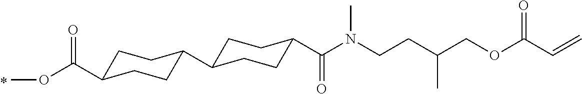 [SMILES: C=CC(=O)OCC(C)CCN(C)C(=O)C1CCC(C2CCC(C(=O)OC)CC2)CC1] |
| 2-12 | 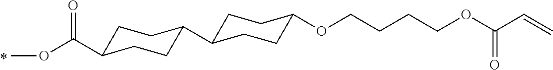 [SMILES: C=CC(=O)OCCCCOC1CCC(C2CCC(C(=O)OC)CC2)CC1] |
| 2-13 | 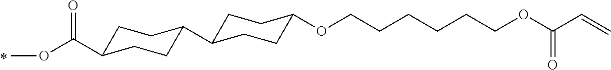 [SMILES: C=CC(=O)OCCCCCCOC1CCC(C2CCC(C(=O)OC)CC2)CC1] |
| 2-14 | 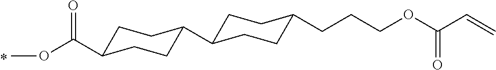 [SMILES: C=CC(=O)OCCCC1CCC(C2CCC(C(=O)OC)CC2)CC1] |

TABLE 3

| | K (side chain structure) |
|---|---|
| 3-1 | 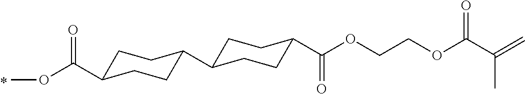 [SMILES: C=C(C)C(=O)OCCOC(=O)C1CCC(C2CCC(C(=O)OC)CC2)CC1] |
| 3-2 | 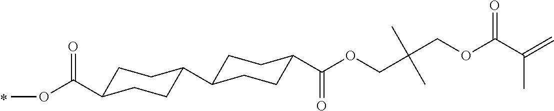 [SMILES: C=C(C)C(=O)OCC(C)(C)COC(=O)C1CCC(C2CCC(C(=O)OC)CC2)CC1] |
| 3-3 | 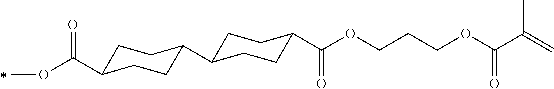 [SMILES: C=C(C)C(=O)OCCCOC(=O)C1CCC(C2CCC(C(=O)OC)CC2)CC1] |
| 3-4 | 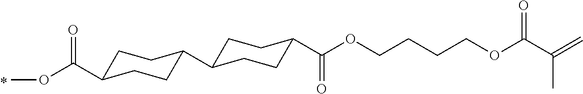 [SMILES: C=C(C)C(=O)OCCCCOC(=O)C1CCC(C2CCC(C(=O)OC)CC2)CC1] |
| 3-5 | 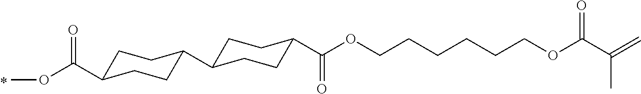 [SMILES: C=C(C)C(=O)OCCCCCCOC(=O)C1CCC(C2CCC(C(=O)OC)CC2)CC1] |
| 3-6 | 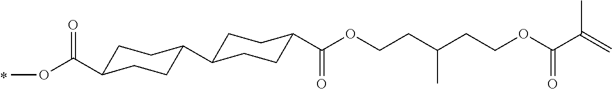 [SMILES: C=C(C)C(=O)OCCC(C)CCOC(=O)C1CCC(C2CCC(C(=O)OC)CC2)CC1] |
| 3-7 | 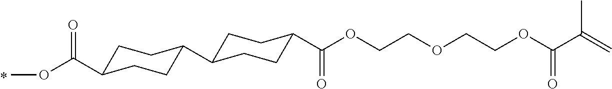 [SMILES: C=C(C)C(=O)OCCOCCOC(=O)C1CCC(C2CCC(C(=O)OC)CC2)CC1] |
| 3-8 | 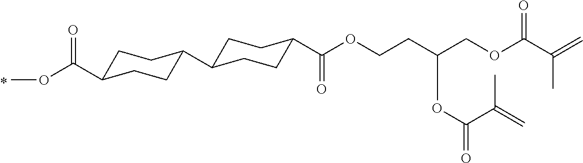 [SMILES: C=C(C)C(=O)OCC(CCOC(=O)C1CCC(C2CCC(C(=O)OC)CC2)CC1)OC(=O)C(=C)C] |
| 3-9 | 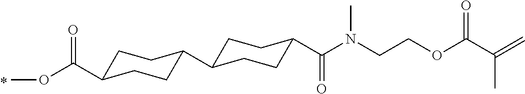 [SMILES: C=C(C)C(=O)OCCN(C)C(=O)C1CCC(C2CCC(C(=O)OC)CC2)CC1] |
| 3-10 | 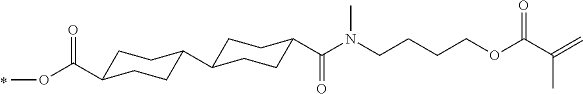 [SMILES: C=C(C)C(=O)OCCCCN(C)C(=O)C1CCC(C2CCC(C(=O)OC)CC2)CC1] |
| 3-11 | 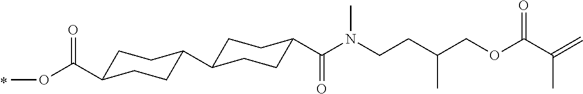 [SMILES: C=C(C)C(=O)OCC(C)CCN(C)C(=O)C1CCC(C2CCC(C(=O)OC)CC2)CC1] |
| 3-12 | 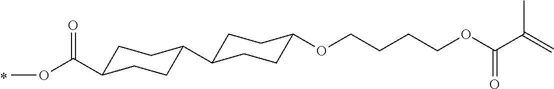 [SMILES: C=C(C)C(=O)OCCCCOC1CCC(C2CCC(C(=O)OC)CC2)CC1] |
| 3-13 | 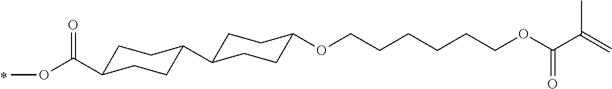 [SMILES: C=C(C)C(=O)OCCCCCCOC1CCC(C2CCC(C(=O)OC)CC2)CC1] |
| 3-14 | 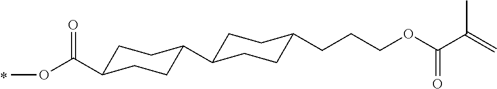 [SMILES: C=C(C)C(=O)OCCCC1CCC(C2CCC(C(=O)OC)CC2)CC1] |

In the present invention, from the reason that the solubility is further improved and the precipitation from a solution is further reduced, it is preferable that, in a case where area percentages of each of the polymerizable liquid crystal compounds P1 to P6 are measured at a measurement wavelength of 254 nm with a high-performance liquid chromatograph (HPLC), a larger one of the area percentages of each of the polymerizable liquid crystal compounds P1 and P3 is defined as C1 and a smaller one thereof is defined as C3, a larger one of the area percentages of the polymerizable liquid crystal compounds P4 and P6 is defined as C4 and a smaller one thereof is defined as C6, and the area percentages of the polymerizable liquid crystal compounds P2 and P5 are each defined as C2 and C5, the following expressions (A), (B), (C), (D), and (E) are satisfied.

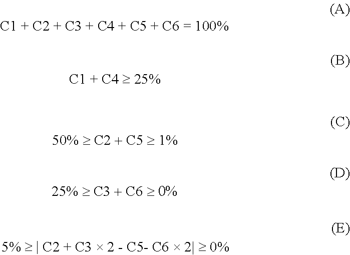

Here, as the area percentages measured by HPLC, area percentages measured under the following conditions are adopted.
Device: high-performance liquid chromatograph measuring device Prominence 20 (manufactured by Shimadzu Corporation)
Column: TSK-GEL ODS-100Z (manufactured by TOSOH Corporation)
Eluent: acetonitrile/water
Buffer: 0.1% phosphoric acid
Measurement solution: 30 L of a measurement target sample diluted with 10 mL of tetrahydrofuran
Measurement wavelength: 254 nm

For the expression (B), it is more preferable that 96%≥C1+C4≥25% is satisfied, and it is still more preferable that 90%≥C1+C4≥40% is satisfied.

Regarding the expression (C), from the viewpoint of further improving the solubility, it is more preferable that 50%≥C2+C5≥4% is satisfied, and it is still more preferable that 50%≥C2+C5≥10% is satisfied.

In the expression (D), it is more preferable that 5%≥C3+C6≥0% is satisfied, and it is still more preferable that 2%≥C3+C6≥0% is satisfied.

In the expression (E), it is more preferable that 4%≥|C2+C3×2−C5−C6×2|≥0% is satisfied, and it is still more preferable that 3%≥|C2+C3×2−C5−C6×2|≥0% is satisfied.

In the present invention, a content of each of the polymerizable liquid crystal compounds P1 to P6 is preferably the amount shown below with respect to the total mass of the polymerizable liquid crystal compounds contained in the polymerizable liquid crystal composition. In the following, among compounds corresponding to Formulae (1) and (3) contained in the polymerizable liquid crystal composition, a compound having a higher content is referred to as the polymerizable liquid crystal compound P1, and a compound having a lower content is referred to as the polymerizable liquid crystal compound P3. Similarly, among compounds corresponding to Formulae (4) and (6) contained in the polymerizable liquid crystal composition, a compound having a higher content is referred to as the polymerizable liquid crystal compound P4, and a compound having a lower content is referred to as the polymerizable liquid crystal compound P6.
Polymerizable liquid crystal compound P1: 20% to 70% by mass
Polymerizable liquid crystal compound P2: 0.1% to 30% by mass
Polymerizable liquid crystal compound P3: 0% to 5% by mass
Polymerizable liquid crystal compound P4: 20% to 70% by mass
Polymerizable liquid crystal compound P5: 0.1% to 30% by mass
Polymerizable liquid crystal compound P6: 0% to 5% by mass

The polymerizable liquid crystal composition according to the embodiment of the present invention exhibits nematic liquid crystallinity or smectic liquid crystallinity in any temperature range, but the expression behavior may be any of enantiotropic or monotropic.

In addition, in the present invention, from the viewpoint of obtaining a phase difference film having higher contrast, it is preferable that the polymerizable liquid crystal composition according to the embodiment of the present invention has smectic liquid crystallinity.

### [Other Polymerizable Compounds]

The polymerizable liquid crystal composition according to the embodiment of the present invention may contain other polymerizable compounds having one or more polymerizable groups, in addition to the above-described polymerizable liquid crystal compounds P1 to P6.

Here, the polymerizable group included in the other polymerizable compounds is not particularly limited, and examples thereof include an acryloyloxy group, a methacryloyloxy group, a vinyl group, a styryl group, and an allyl group. Among these, an acryloyloxy group or a methacryloyloxy group is preferable.

As the other polymerizable compounds, from the reason that durability of the optically anisotropic film to be formed is further improved, other polymerizable compounds having one to four polymerizable groups are preferable, and other polymerizable compounds having two polymerizable groups are more preferable.

Examples of the other polymerizable compounds include polymerizable liquid crystal compounds represented by Formulae (1), (3), (4), and (6), which have different Ar1 and Ar2 structures from those of the polymerizable liquid crystal compounds P1, P3, P4, and P6.

In addition, examples of the other polymerizable compounds include compounds described in paragraphs [0073] and [0074] of JP2016-053709A.

In addition, examples of the other polymerizable compounds include compounds represented by Formulae (M1), (M2), and (M3) described in paragraphs [0030] to [0033] of JP2014-077068A, which have liquid crystallinity, and more specific examples thereof include specific examples described in paragraphs [0046] to [0055] of the same publication.

In addition, as the other polymerizable compounds, compounds having structures of Formulae (1) to (3), described in JP2014-198814A, can also be preferably used, and more specific examples thereof include specific examples described in paragraphs [0020] to [0035], [0042] to [0050], [0056], and [0057] of the same publication.

In a case of containing such other polymerizable compounds, a content thereof is preferably less than 50% by mass with respect to the total mass including the above-described polymerizable liquid crystal compounds P1 to P6.

### [Polymerization Initiator]

The polymerizable liquid crystal composition according to the embodiment of the present invention preferably contains a polymerization initiator.

The polymerization initiator to be used is preferably a photopolymerization initiator capable of initiating a polymerization reaction by irradiation with ultraviolet rays.

Examples of the photopolymerization initiator include α-carbonyl compounds (described in U.S. Pat. Nos. 2,367,661A and 2,367,670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine and phenazine compounds (described in JP1985-105667A (JP-S60-105667A) and U.S. Pat. No. 4,239,850A), oxadiazole compounds (described in U.S. Pat. No. 4,212,970A), and acyl phosphine oxide compounds (described in JP1988-40799B (JP-S63-40799B), JP1993-29234B (JP-H05-29234B), JP1998-95788A (JP-H10-95788A), and JP1998-29997A (JP-H10-29997A)).

In addition, in the present invention, it is also preferable that the polymerization initiator is an oxime-type polymerization initiator; and specific examples of the polymerization initiator include initiators described in paragraphs [0049] to [0052] of WO2017/170443A.

### [Solvent]

From the viewpoint of workability or the like to form the optically anisotropic film, the polymerizable liquid crystal composition according to the embodiment of the present invention preferably contains a solvent.

Examples of the solvent include ketones (for example, acetone, 2-butanone, methyl isobutyl ketone, cyclohexanone, cyclopentanone, and the like), ethers (for example, dioxane, tetrahydrofuran, and the like), aliphatic hydrocarbons (for example, hexane and the like), alicyclic hydrocarbons (for example, cyclohexane and the like), aromatic hydrocarbons (for example, toluene, xylene, trimethylbenzene, and the like), halogenated carbons (for example, dichloromethane, dichloroethane, dichlorobenzene, chlorotoluene, and the like), esters (for example, methyl acetate, ethyl acetate, butyl acetate, and the like), water, alcohols (for example, ethanol, isopropanol, butanol, cyclohexanol, and the like), cellosolves (for example, methyl cellosolve, ethyl cellosolve, and the like), cellosolve acetates, sulfoxides (for example, dimethyl sulfoxide and the like), and amides (for example, dimethyl formamide, dimethyl acetamide, and the like); and these solvents may be used alone or in combination of two or more kinds thereof.

### [Leveling Agent]

From the viewpoint that the surface of the optically anisotropic film is maintained smooth and the alignment is easily controlled, the polymerizable liquid crystal composition according to the embodiment of the present invention preferably contains a leveling agent.

The leveling agent is preferably a fluorine-based leveling agent or a silicon-based leveling agent for a reason that it has a high leveling effect with respect to the addition amount, and the leveling agent is more preferably a fluorine-based leveling agent from the viewpoint that it is less likely to cause bleeding (bloom or bleed).

Specific examples of the leveling agent include compounds described in paragraphs [0079] to [0102] of JP2007-069471A, the compound represented by General Formula (I) described in JP2013-047204A (in particular, compounds described in paragraphs [0020] to [0032]), the compound represented by General Formula (I) described in JP2012-211306A (in particular, compounds described in paragraphs [0022] to [0029]), the liquid crystal alignment accelerator represented by General Formula (I) described in JP2002-129162A (in particular, compounds described in paragraphs [0076] to [0078] and [0082] to [0084]), and compounds represented by General Formulae (I), (II), and (III) described in JP2005-099248A (in particular, compounds described in paragraphs [0092] to [0096]). The leveling agent may also function as an alignment control agent described later.

### [Alignment Control Agent]

The polymerizable liquid crystal composition according to the embodiment of the present invention can contain an alignment control agent as necessary.

With the alignment control agent, in addition to the homogeneous alignment, various alignment states such as homeotropic alignment (vertical alignment), tilt alignment, hybrid alignment, and cholesteric alignment can be formed, and specific alignment states can be controlled and achieved more uniformly and more accurately.

As an alignment control agent which accelerates the homogeneous alignment, for example, a low-molecular-weight alignment control agent or a high-molecular-weight alignment control agent can be used.

With regard to the low-molecular-weight alignment control agent, reference can be made to the description in, for example, paragraphs [0009] to [0083] of JP2002-20363A, paragraphs [0111] to [0120] of JP2006-106662A, and paragraphs [0021] to [0029] of JP2012-211306A, the contents of which are incorporated herein by reference.

In addition, with regard to the high-molecular-weight alignment control agent, reference can be made to the description in, for example, paragraphs [0021] to [0057] of JP2004-198511A and paragraphs [0121] to [0167] of JP2006-106662A, the contents of which are incorporated herein by reference.

In addition, examples of the alignment control agent which forms or accelerates the homeotropic alignment include a boronic acid compound and an onium salt compound, and specifically, reference can be made to compounds described in paragraphs [0023] to [0032] of JP2008-225281A, paragraphs [0052] to [0058] of JP2012-208397A, paragraphs [0024] to [0055] of JP2008-026730A, paragraphs [0043] to [0055] of JP2016-193869A, and the like, the contents of which are incorporated herein by reference.

On the other hand, the cholesteric alignment can be achieved by adding a chiral agent to the polymerizable liquid crystal composition according to the embodiment of the present invention, and it is possible to control the direction of revolution of the cholesteric alignment by its chiral direction. Incidentally, it is possible to control a pitch of the cholesteric alignment in accordance with an alignment regulating force of the chiral agent.

In a case of containing an alignment control agent, a content thereof is preferably 0.01% to 10% by mass, and more preferably 0.05% to 5% by mass with respect to the total solid content mass of the polymerizable liquid crystal composition. In a case where the content is within the range, it is possible to obtain an optically anisotropic film which has no precipitation or phase separation, alignment defects, or the like, and is uniform and highly transparent while achieving a desired alignment state.

These alignment control agents can further impart a polymerizable functional group, in particular, a polymerizable functional group which is polymerizable with a polymerizable liquid crystal compound constituting the polymerizable liquid crystal composition according to the embodiment of the present invention.

### [Polymerization Inhibitor]

From the viewpoint of storing as a solution, the polymerizable liquid crystal composition according to the embodiment of the present invention can contain a polymerization inhibitor as necessary.

As the polymerization inhibitor, a hydroquinone-based polymerization inhibitor, a benzoquinone-based polymerization inhibitor, a hindered phenol-based polymerization inhibitor, a hindered amine-based polymerization inhibitor, a stable radical-based polymerization inhibitor, or the like can be used.

In addition, since polymerization is likely to occur due to the decrease in oxygen concentration in the solution, it is possible to suppress the polymerization by performing an operation such as securing a sufficient large free space volume of the storage container, and supplying (ventilating) oxygen (air) to the solution during storage.

In addition, since the polymerization is likely to occur as the storage temperature increases, the storage temperature is preferably kept at room temperature or lower, and it is preferably refrigerated at 10° C. or lower.

### [Other Components]

The polymerizable liquid crystal composition according to the embodiment of the present invention may contain a component other than the above-described components, and examples thereof include a liquid crystal compound other than the above-described polymerizable liquid crystal compounds, a surfactant, a tilt angle control agent, an alignment assistant, a plasticizer, and a crosslinking agent.

### [Optically Anisotropic Film]

The optically anisotropic film according to the embodiment of the present invention is an optically anisotropic film obtained by fixing an alignment state of the above-described polymerizable liquid crystal composition according to the embodiment of the present invention.

Examples of a method for forming the optically anisotropic film include a method of using the above-described polymerizable liquid crystal composition according to the embodiment of the present invention to obtain a desired alignment state, and then fixing an alignment state by polymerization.

Here, polymerization conditions are not particularly limited, but ultraviolet rays are preferably used in the polymerization by light irradiation. An irradiation amount is preferably 10 mJ/cm² to 50 J/cm², more preferably 20 mJ/cm² to 5 J/cm², still more preferably 30 mJ/cm² to 3 J/cm², and particularly preferably 50 to 1,000 mJ/cm². In order to promote the polymerization reaction, the treatment may be performed under heating conditions.

In the present invention, the optically anisotropic film can be formed on any support in the optical film according to the embodiment of the present invention, which will be described later, or on any polarizer in the polarizing plate according to the embodiment of the present invention, which will be described later.

The optically anisotropic film of the embodiment of the present invention preferably satisfies the following expression (F).

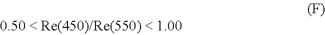

The optically anisotropic film according to the embodiment of the present invention is preferably a positive A-plate or a positive C-plate, and more preferably a positive A-plate.

Here, the positive A-plate and the positive C-plate are defined as follows.

The positive A-plate satisfies a relationship of Expression (A1) and the positive C-plate satisfies a relationship of Expression (C1), assuming that a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. The positive A-plate has an Rth showing a positive value and the positive C-plate has an Rth showing a negative value.

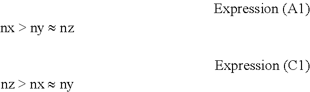

The symbol “˜” encompasses not only a case where both sides are completely the same as each other but also a case where the both sides are substantially the same as each other.

The expression “substantially the same” means that, in the positive A-plate, for example, a case where (ny-nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”. In addition, in the positive C-plate, for example, a case where (nx−ny)×d (in which d is a thickness of a film) is 0 to 10 nm, and preferably 0 to 5 nm is also included in “nx≈ny”.

In a case where the optically anisotropic film according to the embodiment of the present invention is the positive A-plate, from the viewpoint that the retardation layer functions as a λ/4 plate, Re(550) is preferably 100 to 180 nm, more preferably 120 to 160 nm, still more preferably 130 to 150 nm, and particularly preferably 130 to 140 nm.

Here, the “λ/4 plate” is a plate having a V/4 function, specifically, a plate having a function of converting linearly polarized light having a specific wavelength into circularly polarized light (or converting circularly polarized light into linearly polarized light).

### [Optical Film]

The optical film according to the embodiment of the present invention is an optical film having the optically anisotropic film according to the embodiment of the present invention.

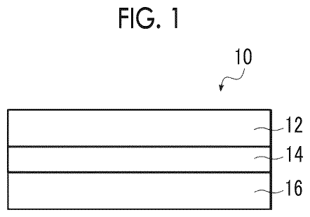

A structure of the optical film will be described with reference to FIG. 1. FIG. 1 is a schematic cross-sectional view showing an example of the optical film.

FIG. 1 is a schematic view, and the thicknesses relationship, the positional relationship, and the like of the respective layers are not necessarily consistent with actual ones; and a support and an alignment film shown in FIG. 1 are optional constitutional members.

An optical film 10 shown in FIG. 1 includes, in the following order, a support 16, an alignment film 14, and an optically anisotropic film 12 obtained by subjecting an alignment state of the polymerizable liquid crystal composition according to the embodiment of the present invention to fixing.

Hereinafter, various members used for the optical film will be described in detail.

### [Optically Anisotropic Film]

The optically anisotropic film included in the optical film according to the embodiment of the present invention is the above-described optically anisotropic film according to the embodiment of the present invention.

In the optical film according to the embodiment of the present invention, a thickness of the above-described optically anisotropic film is not particularly limited, but is preferably 0.1 to m and more preferably 0.5 to 5 μm.

### [Support]

The optical film according to the embodiment of the present invention may have a support as a substrate for forming the optically anisotropic film as described above.

Such a support is preferably transparent, and specifically, the support preferably has a light transmittance of 80% or more.

Examples of such a support include a glass substrate and a polymer film; and examples of a material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

In addition, an aspect in which a polarizer described later may also function as the support is also adopted.

In the present invention, a thickness of the above-described support is not particularly limited, but is preferably 5 to 60 μm and more preferably 5 to 30 μm.

### [Alignment Film]

In a case where the optical film according to the embodiment of the present invention has any of the above-described supports, it is preferable that the optical film has an alignment film between the support and the optically anisotropic film. An aspect in which the above-described support may also function as the alignment film is also adopted.

The alignment film generally contains a polymer as a main component. A polymer material for an alignment film is described in many documents, and many commercially available products can be used.

The polymer material used in the present invention is preferably polyvinyl alcohol, polyimide, or derivatives thereof. A modified or non-modified polyvinyl alcohol is particularly preferable.

Examples of the alignment film which can be used in the present invention include alignment films described in Line 24 on Page 43 to Line 8 on Page 49 of WO2001/88574A; modified polyvinyl alcohols described in paragraphs [0071] to [0095] of JP3907735B; and liquid crystal alignment film formed by a liquid crystal aligning agent, described in JP2012-155308A.

In the present invention, for the reason that it is possible to prevent deterioration in the surface condition by avoiding a contact with the surface of the alignment film upon formation of the alignment film, a photo-alignment film is also preferably used as the alignment film.

The photo-alignment film is not particularly limited, but polymer materials such as a polyamide compound and a polyimide compound, described in paragraphs [0024] to [0043] of WO2005/096041A; liquid crystal alignment film formed by a liquid crystal aligning agent having a photo-aligned group, described in JP2012-155308A; trade name LPP-JP265CP manufactured by Rolic Technologies Ltd.; or the like can be used.

In addition, in the present invention, a thickness of the above-described alignment film is not particularly limited, but from the viewpoint of forming an optically anisotropic film having a homogeneous film thickness by alleviating the surface roughness which can be present on the support, it is preferably 0.01 to 10 μm, more preferably 0.01 to 1 μm, and still more preferably 0.01 to 0.5 μm.

### [Other Optically Anisotropic Films]

The optical film according to the embodiment of the present invention may include an optically anisotropic film, in addition to the optically anisotropic film according to the embodiment of the present invention.

That is, the optical film according to the embodiment of the present invention may have a laminated structure of the optically anisotropic film according to the embodiment of the present invention and other optically anisotropic films.

Such other optically anisotropic films are not particularly limited as long as the optically anisotropic films are obtained by not formulating any one of the polymerizable liquid crystal compound (I) and the polymerizable compound (II), but using the above-described other polymerizable compounds (in particular, liquid crystal compounds).

Here, in general, the liquid crystal compound can be classified into a rod-like type and a disk-like type according to the shape thereof. Each of the types can further be classified into a low-molecular-weight type and a high-molecular-weight type. The term “high-molecular-weight” generally refers to a compound having a degree of polymerization of 100 or more (Polymer Physics-Phase Transition Dynamics, written by Masao Doi, p. 2, published by Iwanami Shoten, 1992). In the present invention, any liquid crystal compound can be used, and it is preferable to use a rod-like liquid crystal compound or a discotic liquid crystal compound (disk-like liquid crystal compound). A mixture of two or more kinds of the rod-like liquid crystal compounds, a mixture of two or more kinds of the disk-like liquid crystal compounds, or a mixture of the rod-like liquid crystal compound and the disk-like liquid crystal compound may be used. In order to immobilize the above-described liquid crystal compound, it is more preferable that the other optically anisotropic films are formed of a rod-like liquid crystal compound or disk-like liquid crystal compound having a polymerizable group, and it is still more preferable that the liquid crystal compound has two or more polymerizable groups in one molecule. In the case of the mixture of two or more kinds of liquid crystal compounds, at least one kind of the liquid crystal compound preferably has two or more polymerizable groups in one molecule.

As the rod-like liquid crystal compound, for example, rod-like liquid crystal compounds described in Claim 1 of JP1999-513019A (JP-H11-513019A) or paragraphs 0026 to 0098 of JP2005-289980A can be preferably used; and as the discotic liquid crystal compounds, for example, discotic liquid crystal compounds described in paragraphs 0020 to 0067 of JP2007-108732A or paragraphs 0013 to 0108 of JP2010-244038A can be preferably used, but the liquid crystal compounds are not limited thereto.

### [Ultraviolet Absorber]

The optical film according to the embodiment of the present invention preferably contains an ultraviolet (UV) absorber in consideration of an effect of external light (particularly ultraviolet rays).

The ultraviolet absorber may be contained in the optically anisotropic film according to the embodiment of the present invention, or may also be contained in a member other than an optically anisotropic film constituting the optical film according to the embodiment of the present invention. Suitable examples of the member other than the optically anisotropic film include a support.

As the ultraviolet absorber, any one of ultraviolet absorbers known in the related art, which can express ultraviolet absorptivity, can be used. Among such ultraviolet absorbers, a benzotriazole-based ultraviolet absorber or a hydroxyphenyltriazine-based ultraviolet absorber is preferably used from the viewpoint that it has high ultraviolet absorptivity and ultraviolet absorbing ability (ultraviolet-shielding ability) used for an image display apparatus is obtained.

In addition, in order to broaden absorption width of ultraviolet rays, two or more kinds of ultraviolet absorbers having different maximum absorption wavelengths can be used in combination.

Specific examples of the ultraviolet absorber include compounds described in paragraphs [0258] and [0259] of JP2012-18395A and compounds described in paragraphs [0055] to [0105] of JP2007-72163A.

In addition, as a commercially available product thereof, for example, Tinuvin 400, Tinuvin 405, Tinuvin 460, Tinuvin 477, Tinuvin 479, Tinuvin 1577, or the like (all manufactured by BASF) can be used.

### [Polarizing Plate]

The polarizing plate according to the embodiment of the present invention includes the above-described optical film according to the embodiment of the present invention and a polarizer.

In addition, in a case where the above-described optically anisotropic film according to the embodiment of the present invention is a V/4 plate (positive A-plate), the polarizing plate according to the embodiment of the present invention can be used as a circularly polarizing plate.

In addition, in the polarizing plate according to the embodiment of the present invention, in a case where the above-described optically anisotropic film according to the embodiment of the present invention is a V/4 plate (positive A-plate), an angle between a slow axis of the V/4 plate and an absorption axis of the polarizer, which will be described later, is preferably 30° to 60°, more preferably 40° to 50°, still more preferably 42° to 48°, and particularly preferably 45°.

Here, the “slow axis” of the V/4 plate means a direction in which a refractive index in the plane of the λ/4 plate is maximum, and the “absorption axis” of the polarizer means a direction in which an absorbance is highest.

### [Polarizer]

The polarizer of the polarizing plate according to the embodiment of the present invention is not particularly limited as long as the polarizer is a member having a function of converting light into specific linearly polarized light, and a known absorptive type polarizer and reflective type polarizer in the related art can be used.

An iodine-based polarizer, a dye-based polarizer using a dichroic dye, a polyene-based polarizer, or the like is used as the absorptive type polarizer. The iodine-based polarizer and the dye-based polarizer include a coating type polarizer and a stretching type polarizer, and any one of these polarizers can be applied. However, a polarizer which is produced by allowing polyvinyl alcohol to adsorb iodine or a dichroic dye and performing stretching is preferable.

In addition, examples of a method of obtaining a polarizer by performing stretching and dyeing in a state of a laminated film in which a polyvinyl alcohol layer is formed on a substrate include methods disclosed in JP5048120B, JP5143918B, JP4691205B, JP4751481B, and JP4751486B, and known technologies related to these polarizers can be preferably used.

A polarizer in which thin films having different birefringence are laminated, a wire grid type polarizer, a polarizer in which a cholesteric liquid crystal having a selective reflection range and a ¼ wavelength plate are combined, or the like is used as the reflective type polarizer.

Among these, from the viewpoint of more excellent adhesiveness, a polarizer containing a polyvinyl alcohol resin (polymer including —CH₂—CHOH— as a repeating unit; in particular, at least one selected from the group consisting of polyvinyl alcohol and an ethylene-vinyl alcohol copolymer) is preferable.

In the present invention, the thickness of the polarizer is not particularly limited, but is preferably 3 μm to 60 μm, more preferably 5 μm to 30 μm, and even more preferably 5 μm to 15 μm.

### [Pressure Sensitive Adhesive Layer]

The polarizing plate according to the embodiment of the present invention may include a pressure sensitive adhesive layer arranged between the optically anisotropic film in the optical film according to the embodiment of the present invention and the polarizer.

The pressure sensitive adhesive layer used for lamination of the optically anisotropic film and the polarizer is, for example, a substance in which a ratio (tan δ=G″/G′) of loss elastic modulus G″ to storage elastic modulus G′ is 0.001 to 1.5, where G′ and G″ are measured with a dynamic viscoelasticity measurement. Such a substance includes a so-called pressure sensitive adhesive or easily creepable substance. Examples of the pressure sensitive adhesive which can be used in the present invention include a polyvinyl alcohol-based pressure sensitive adhesive, but the gluing agent is not limited thereto.

### [Image Display Apparatus]

An image display apparatus according to an embodiment of the present invention is an image display apparatus having the optical film according to the embodiment of the present invention or the polarizing plate according to the embodiment of the present invention.

A display element used for the image display apparatus according to the embodiment of the present invention is not particularly limited, and examples thereof include a liquid crystal cell, an organic electroluminescent (hereinafter, abbreviated as “EL”) display panel, and a plasma display panel.

Among these, a liquid crystal cell or an organic EL display panel is preferable, and a liquid crystal cell is more preferable. That is, the image display apparatus according to the embodiment of the present invention is preferably a liquid crystal display device using a liquid crystal cell as the display element or an organic EL display device using an organic EL display panel as the display element, and is more preferably a liquid crystal display device.

### [Liquid Crystal Display Device]

A liquid crystal display device as an example of the image display apparatus according to the embodiment of the present invention is a liquid crystal display device including the polarizing plate according to the embodiment of the present invention and a liquid crystal cell.

In the present invention, it is preferable that the polarizing plate according to the embodiment of the present invention is used for a polarizing plate of the front side, out of polarizing plates provided on both sides of the liquid crystal cell, and it is more preferable that the polarizing plate according to the embodiment of the present invention is used for the polarizing plates on the front and rear sides.

Hereinafter, the liquid crystal cell constituting the liquid crystal display device will be described in detail.

### <Liquid Crystal Cell>

The liquid crystal cell used for the liquid crystal display device is preferably a vertical alignment (VA) mode, an optically compensated bend (OCB) mode, an in-plane-switching (IPS) mode, or a twisted nematic (TN) mode, but the liquid crystal cell is not limited thereto.

In the liquid crystal cell in a TN mode, rod-like liquid crystalline molecules are substantially horizontally aligned at the time of no voltage application and further twisted aligned at 600 to 120°. The liquid crystal cell in a TN mode is most frequently used as a color TFT liquid crystal display device and is described in a plurality of documents.

In the liquid crystal cell in a VA mode, rod-like liquid crystalline molecules are substantially vertically aligned at the time of no voltage application. Examples of the VA mode liquid crystal cells include (1) a VA mode liquid crystal cell in a narrow sense (described in JP1990-176625A (JP-H2-176625A)) in which rod-like liquid crystal molecules are substantially aligned vertically in a case where no voltage is applied thereto and are substantially aligned horizontally in a case where a voltage is applied thereto, (2) a multi-domain VA mode (MVA mode) liquid crystal cell for enlarging the viewing angle (SID97, described in Digest of Tech. Papers (Proceedings) 28 (1997) 845), (3) a liquid crystal cell in a mode (n-ASM mode) in which rod-like liquid crystal molecules are substantially aligned vertically in a case where no voltage is applied thereto and are aligned in twisted multi-domain alignment in a case where a voltage is applied thereto (described in Proceedings of Japanese Liquid Crystal Conference, 58 and 59 (1998)), and (4) a SURVIVAL mode liquid crystal cell (presented in LCD International 98). The liquid crystal cell may be any one of a patterned vertical alignment (PVA) type, an optical alignment type, and a polymer-sustained alignment (PSA) type. These modes are described in detail in JP2006-215326A and JP2008-538819A.

In an IPS mode liquid crystal cell, rod-like liquid crystal molecules are substantially aligned parallel to a substrate and application of an electric field parallel to a surface of the substrate causes the liquid crystal molecules to respond planarly. In the IPS mode, black display is carried out in a state where no electric field is applied, and absorption axes of a pair of upper and lower polarizing plates are orthogonal to each other. A method of reducing light leakage during black display in an oblique direction and improve the viewing angle using an optical compensation sheet is disclosed in JP1998-54982A(JP-H10-54982A), JP1999-202323A (JP-H11-202323A), JP1997-292522A(JP-H9-292522A), JP1999-133408A(JP-H11-133408A), JP1999-305217A (JP-H11-305217A), and JP1998-307291A (JP-H10-307291A).

### [Organic EL Display Device]

Suitable examples of the organic EL display device which is an example of the image display apparatus according to the embodiment of the present invention include an aspect which includes, from a viewing side, a polarizer, a V/4 plate (a positive A-plate) including the optically anisotropic film according to the embodiment of the present invention, and an organic EL display panel in this order.

In addition, the organic EL display panel is a display panel formed of an organic EL element obtained by sandwiching an organic light emitting layer (organic electroluminescence layer) between electrodes (between a cathode and an anode). The configuration of the organic EL display panel is not particularly limited, and a known configuration is employed.

### [Method for Producing Polymerizable Liquid Crystal Composition]

The method for producing a polymerizable liquid crystal composition according to a first aspect of the present invention is a method for producing a polymerizable liquid crystal composition, in which the polymerizable liquid crystal compounds P1 and P3 respectively represented by Formulae (1) and (3) described above are dissolved in a solvent and reacted (hereinafter, also abbreviated as “side chain exchange reaction”) to obtain a polymerizable liquid crystal composition containing the polymerizable liquid crystal compounds P1 to P3 respectively represented by Formulae (1) to (3) described above and the solvent.

The method for producing a polymerizable liquid crystal composition according to a second aspect of the present invention is a method for producing a polymerizable liquid crystal composition, in which the polymerizable liquid crystal compounds P1 and P4 respectively represented by Formulae (1) and (4) described above are dissolved in a solvent and reacted (side chain exchange reaction) to obtain a polymerizable liquid crystal composition containing the polymerizable liquid crystal compounds P1, P2, P4, and P5 respectively represented by Formulae (1), (2), (4), and (5) described above and the solvent; and it is preferable that the method for producing a polymerizable liquid crystal composition is a method for producing a polymerizable liquid crystal composition, in which a polymerizable liquid crystal composition containing the polymerizable liquid crystal compounds P1 to P6 represented by Formulae (1) to (6) described above and the solvent are obtained.

Here, examples of the polymerizable liquid crystal compounds P1 and P3 and the solvent used in the first aspect include the same ones as those described in the polymerizable liquid crystal composition according to the embodiment of the present invention.

In addition, examples of the polymerizable liquid crystal compounds P1 and P4 and the solvent used in the second aspect include the same ones as those described in the polymerizable liquid crystal composition according to the embodiment of the present invention.

### [Reaction Conditions]

In the method for producing a polymerizable liquid crystal composition according to the first aspect of the present invention, a ratio of the polymerizable liquid crystal compounds P1 and P3 in the side chain exchange reaction is not particularly limited, but from the viewpoint of reaction rate, it is preferable to set the molar ratio thereof to 1:1.

Similarly, in the method for producing a polymerizable liquid crystal composition according to the second aspect of the present invention, a ratio of the polymerizable liquid crystal compounds P1 and P4 in the side chain exchange reaction is not particularly limited, but from the viewpoint of reaction rate, it is preferable to set the molar ratio thereof to 1:1.

In addition, from the viewpoint of improving the reaction rate, a concentration of the reaction substrate in the side chain exchange reaction in the first and second aspects is preferably high. Specifically, the concentration of the reaction substrate is preferably 10% or more, more preferably 15% or more, and still more preferably 20% or more. A concentration of solid contents may be diluted by adding a solvent after the reaction, and in this case, a solvent different from the solvent used for the reaction may be added.

### [Catalyst]

In the method for producing a polymerizable liquid crystal composition according to the first and the second aspects of the present invention, from the viewpoint of rapidly proceeding the side chain exchange reaction, it is preferable to add a catalyst before the side chain exchange reaction.

As the catalyst, an acidic compound, a basic compound, or the like can be used; and among these, a basic compound is preferably used.

As the acidic compound, for example, a Bronsted acid such as hydrochloric acid or sulfuric acid; an organic acid such as carboxylic acid, sulfonic acid, and phosphoric acid, or a Lewis acid such as aluminum oxide and titanium oxide can be used; and from the viewpoint of removal of the catalyst, a solid acid is preferable.

As the basic compound, for example, organic amines such as triethylamine and N,N-diisopropylethylamine (hereinafter, DIPEA) are preferable.

In addition, in the method for producing a polymerizable liquid crystal composition according to the first and second aspects of the present invention, in a case where the catalyst (particularly, the basic compound) is added before the side chain exchange reaction, from the viewpoint of suppressing fluctuation in the compositional ratio and imparting storage stability, it is preferable that the catalyst is removed after the side chain exchange reaction.

A method of removing the catalyst is not particularly limited, and examples thereof include removal by filtration, removal using an adsorbent, and removal by a liquid separation operation, a distillation operation, or the like.

For example, as the adsorbent which adsorbs the above-described basic compound, an ion exchange resin, an inorganic oxide-based adsorbent, activated carbon, and the like can be used; as the ion exchange resin, AmberLyst (manufactured by DuPont), and the like can be used; as the inorganic oxide-based adsorbent, KYOWAAD 700 (manufactured by Kyowa Chemical Industry Co., Ltd.) and the like can be used; and as the activated carbon, granular white heron (manufactured by Osaka Gas Chemicals Co., Ltd.) and the like can be used.

In addition, the residual rate of the catalyst is preferably low, but the catalyst may remain in a range which does not affect the storage stability. Specifically, a content of the catalyst is preferably 10 ppm or less, more preferably 1 ppm or less, and still more preferably 0.2 ppm or less with respect to the composition solution.

### [Control of Reaction Rate in Side Chain Exchange Reaction]

From the viewpoint of reaction control, it is preferable that the side chain exchange reaction is close to an equilibrium state because the compositional ratio is stabilized.

That is, in a case where the polymerizable liquid crystal compounds P1 and P3 are mixed and reacted at the molar ratio of 1:1, the total content of P2 in the equilibrium state is preferably 20% or more, more preferably 30% or more, and still more preferably 40% or more.

Similarly, in a case where the polymerizable liquid crystal compounds P1 and P4 are mixed and reacted at the molar ratio of 1:1, the total content of P2 and P5 in the equilibrium state is preferably 20% or more, more preferably 30% or more, and still more preferably 40% or more.

### [Preparation of Polymerizable Liquid Crystal Composition]

The above-described polymerizable liquid crystal composition according to the embodiment of the present invention may be a polymerizable liquid crystal composition prepared by the method for producing a polymerizable liquid crystal composition according to the second aspect of the present invention described above, but may be a composition obtained by adding any compound to the polymerizable liquid crystal composition prepared by the method for producing a polymerizable liquid crystal composition according to the second aspect of the present invention described above. Examples of the compound which can be added include a polymerizable compound, a polymerization initiator, and an alignment control agent.

In addition, these compounds may be added to the polymerizable liquid crystal composition during the side chain exchange reaction, and for example, a reaction may occur by adding the catalyst such as the basic compound to a composition for producing an optically anisotropic film. From the viewpoint of reaction control and removal of the catalyst after the reaction, it is preferable that the reaction is performed using only the polymerizable liquid crystal involved in the reaction, and then the composition for producing an optically anisotropic film is prepared.

### EXAMPLES

Hereinbelow, the present invention will be described in more detail with reference to Examples. The materials, amounts used, proportions, treatment contents, treatment procedures, and the like shown in the following examples can be modified as appropriate in the range of not departing from the spirit of the present invention. Therefore, the scope of the present invention should not be construed as being limited to Examples.

For polymerizable liquid crystal compounds used in Examples and Comparative Example described below, structures of the core portion and the ClogP values thereof, and structures of the side chain portion and the ClogP values thereof are shown below.

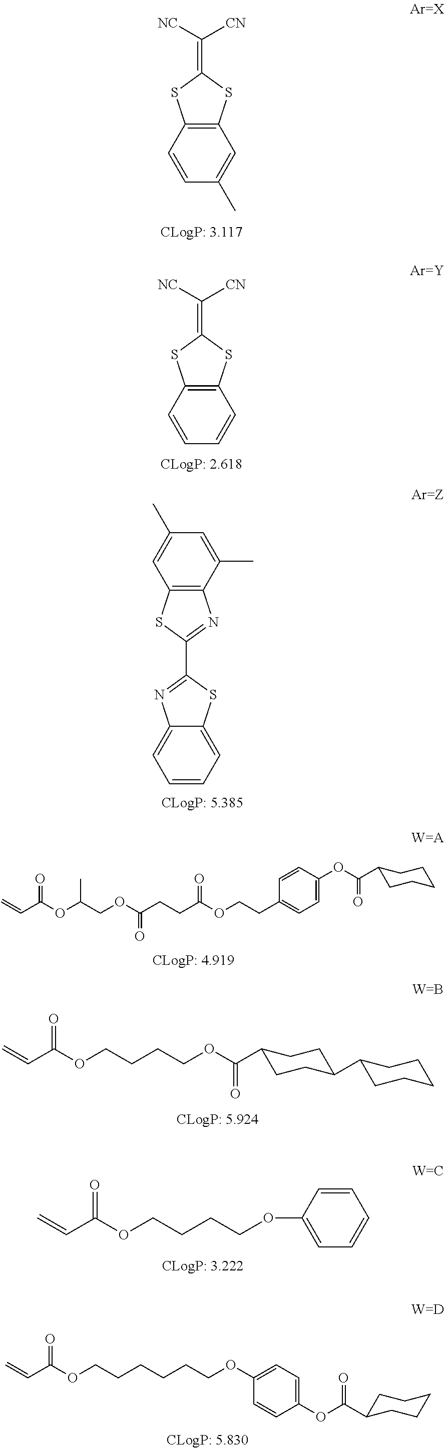

### <Preparation of Polymerizable Liquid Crystal Composition by Side Chain Exchange Reaction>

### Example 1

A reaction solution 1 having the following formulation was prepared, heated to 60° C., uniformly dissolved, and then cooled to 40° C.

Reaction solution 1

| | | |
|---|---|---|
| Polymerizable liquid crystal AXA shown below | 55.9 | parts by mass |
| Polymerizable liquid crystal BYB shown below | 44.1 | parts by mass |
| Cyclopentanone | 300 | parts by mass |

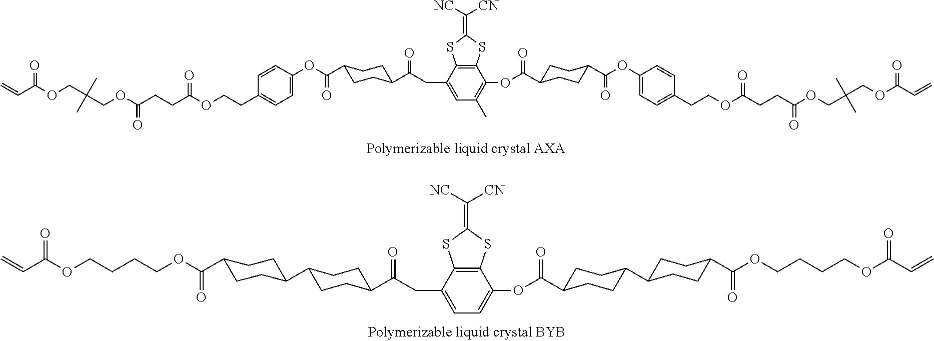

A group adjacent to the acryloyloxy group in the polymerizable liquid crystal AXA represents a propylene group (a group in which a methyl group is substituted with an ethylene group), and represents a mixture of regioisomers in which positions of the methyl groups are different.

0.38 parts by mass of N,N-diisopropylethylamine (DIPEA) as a basic compound was added to the reaction solution 1 cooled to 40° C., and the mixture was stirred at 40° C. for 5 hours.

Next, 7.6 parts by mass of KYOWAAD 700SEN-S(manufactured by Kyowa Chemical Industry Co., Ltd.) as an adsorbent was added to the reaction solution, and the mixture was stirred for 3 hours while the temperature was lowered to room temperature.

Next, after filtering KYOWAAD 700SEN-S, the same amount of KYOWAAD 700SEN-S was added to the filtrate, and the mixture was filtered to obtain a cyclopentanone solution of the polymerizable liquid crystal composition 1. Cyclopentanone was used as a washing solution during the filtration, and the concentration of solid contents was adjusted to 20% by mass. The compositional ratio of the polymerizable liquid crystal composition 1 was confirmed by HPLC, and it was confirmed that the compositional ratio was the following ratio.

Area percentage of polymerizable liquid
crystal composition 1 by HPLC

P1: polymerizable liquid crystal AXA shown below 43.6%
P2: polymerizable liquid crystal AXB shown below 11.9%
P3: polymerizable liquid crystal BXB shown below 0.2%
P4: polymerizable liquid crystal BYB shown below 34.5%
P5: polymerizable liquid crystal AYB shown below 9.1%
P6: polymerizable liquid crystal AYA shown below 0.7%

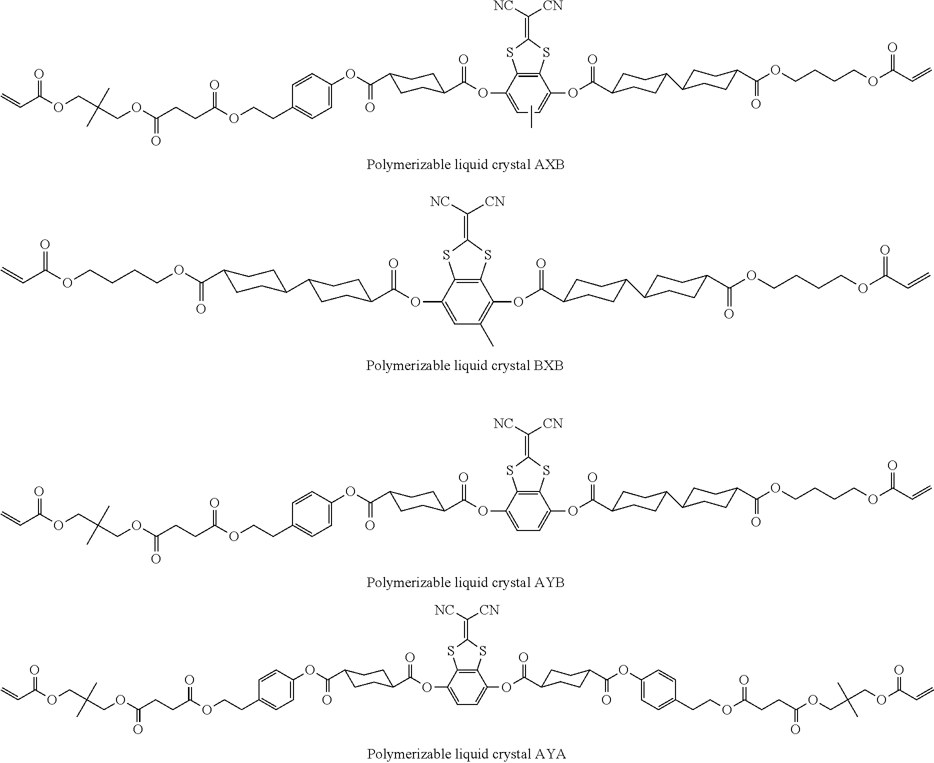

The core aromatic ring in the polymerizable liquid crystal AXB represents a mixture of regioisomers having one methyl substituent and different positions of the methyl group.

In addition, the residual DIPEA in the polymerizable liquid crystal composition 1 was equal to or lower than the detection limit (0.1 ppm).

In addition, the polymerizable liquid crystal composition 1 was allowed to flow onto a glass plate, and the solid content after drying and removing the solvent was observed with a polarization microscope while controlling the temperature using a heating stage (manufactured by METTLER TOLEDO), and thus it was confirmed that the composition exhibited smectic property.

### Example 2

A polymerizable liquid crystal composition 2 was obtained in the same manner as in Example 1, except that the reaction solution 1 having the same formulation as in Example 1 was used and the reaction temperature was set to 50° C. The compositional ratio of the polymerizable liquid crystal composition 2 was confirmed by HPLC, and it was confirmed that the compositional ratio was the following ratio.

Area percentage of polymerizable liquid
crystal composition 2 by HPLC

| | |
|---|---|
| P1: polymerizable liquid crystal AXA | 28.0% |
| P2: polymerizable liquid crystal AXB | 25.2% |
| P3: polymerizable liquid crystal BXB | 1.3% |
| P4: polymerizable liquid crystal BYB | 22.5% |
| P5: polymerizable liquid crystal AYB | 19.4% |
| P6: polymerizable liquid crystal AYA | 3.6% |

In addition, the residual DIPEA in the polymerizable liquid crystal composition 2 was equal to or lower than the detection limit (0.1 ppm).

In addition, the polymerizable liquid crystal composition 1 was allowed to flow onto a glass plate, and the solid content after drying and removing the solvent was observed with a polarization microscope while controlling the temperature using a heating stage (manufactured by METTLER TOLEDO), and thus it was confirmed that the composition exhibited smectic property.

### Example 3

A reaction solution 3 having the following formulation was prepared, heated to 60° C., uniformly dissolved, and then cooled to 50° C.

Reaction solution 3

| | | |
|---|---|---|
| Polymerizable liquid crystal AXA shown above | 62.5 | parts by mass |
| Polymerizable liquid crystal CYC shown below | 37.5 | parts by mass |
| Cyclopentanone | 300 | parts by mass |

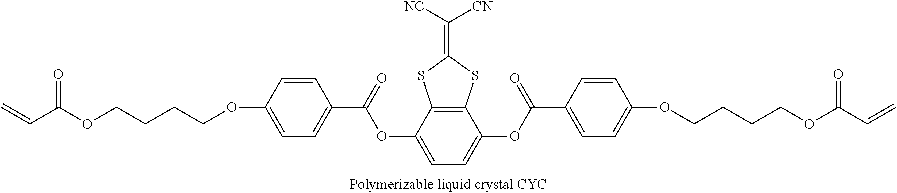 [SMILES: C=CC(=O)OCCCCOc1ccc(C(=O)Oc2ccc(OC(=O)c3ccc(OCCCCOC(=O)C=C)cc3)c3c2SC(=C(C#N)C#N)S3)cc1]

0.42 parts by mass of DIPEA was added to the cyclopentanone solution cooled to 50° C., and the mixture was stirred at 50° C. for 3 hours.

Next, 7.6 parts by mass of KYOWAAD 700SEN-S(manufactured by Kyowa Chemical Industry Co., Ltd.) was added to the reaction solution, and the mixture was stirred for 3 hours while the temperature was lowered to room temperature.

Next, after filtering KYOWAAD 700SEN-S, the same amount of KYOWAAD 700SEN-S was added to the filtrate, and the mixture was filtered to obtain a cyclopentanone solution of the polymerizable liquid crystal composition 3. Cyclopentanone was used as a washing solution during the filtration, and the concentration of solid contents was adjusted to 20 wt %. The compositional ratio of the polymerizable liquid crystal composition 3 was confirmed by HPLC, and it was confirmed that the compositional ratio was the following ratio.

Area percentage of polymerizable liquid
crystal composition 3 by HPLC

P1: polymerizable liquid crystal AXA shown above 12.4%
P2: polymerizable liquid crystal AXC shown below 14.4%
P3: polymerizable liquid crystal CXC shown below 0.2%
P4: polymerizable liquid crystal CYC shown above 54.4%
P5: polymerizable liquid crystal AYC shown below 18.4%
P6: polymerizable liquid crystal AYA shown above 0.2%

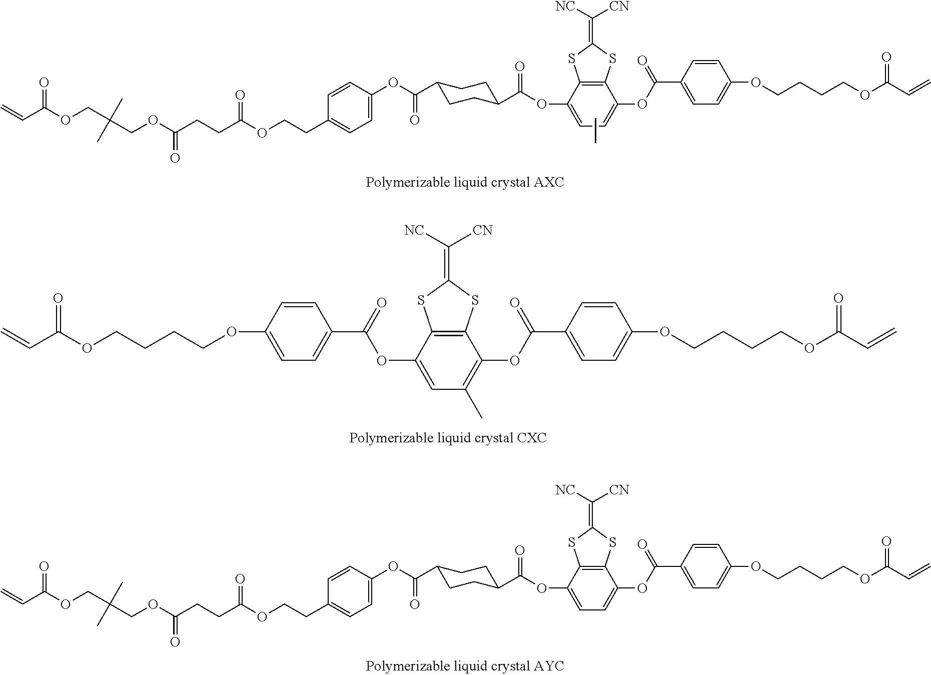

### Example 4

A reaction solution 4 having the following formulation was prepared, heated to 60° C., uniformly dissolved, and then cooled to 50° C.

Reaction solution 4

| | | |
|---|---|---|
| Polymerizable liquid crystal DZD shown below | 47.8 | parts by mass |
| Polymerizable liquid crystal AXA shown above | 52.2 | parts by mass |
| Cyclopentanone | 300 | parts by mass |

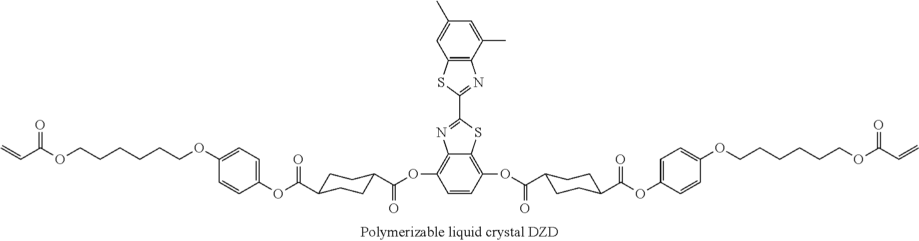 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c4sc(-c5nc6c(C)cc(C)cc6s5)nc34)CC2)cc1]

0.35 parts by mass of DIPEA was added to the cyclopentanone solution cooled to 50° C., and the mixture was stirred at 50° C. for 3 hours.

Next, 7.6 parts by mass of KYOWAAD 700SEN-S(manufactured by Kyowa Chemical Industry Co., Ltd.) was added to the reaction solution, and the mixture was stirred for 3 hours while the temperature was lowered to room temperature.

Next, after filtering KYOWAAD 700SEN-S, the same amount of KYOWAAD 700SEN-S was added to the filtrate, and the mixture was filtered to obtain a cyclopentanone solution of the polymerizable liquid crystal composition 3. Cyclopentanone was used as a washing solution during the filtration, and the concentration of solid contents was adjusted to 20 wt %. The compositional ratio of the polymerizable liquid crystal composition 4 was confirmed by HPLC, and it was confirmed that the compositional ratio was the following ratio.

Area percentage of polymerizable liquid
crystal composition 4 by HPLC

P1: polymerizable liquid crystal DZD shown above 61.4%
P2: polymerizable liquid crystal AZD shown below 3.5%
P3: polymerizable liquid crystal AZA shown below 0.0%
P4: polymerizable liquid crystal AXA shown above 32.7%
P5: polymerizable liquid crystal AXD shown below 2.4%
P6: polymerizable liquid crystal DXD shown below 0.0%

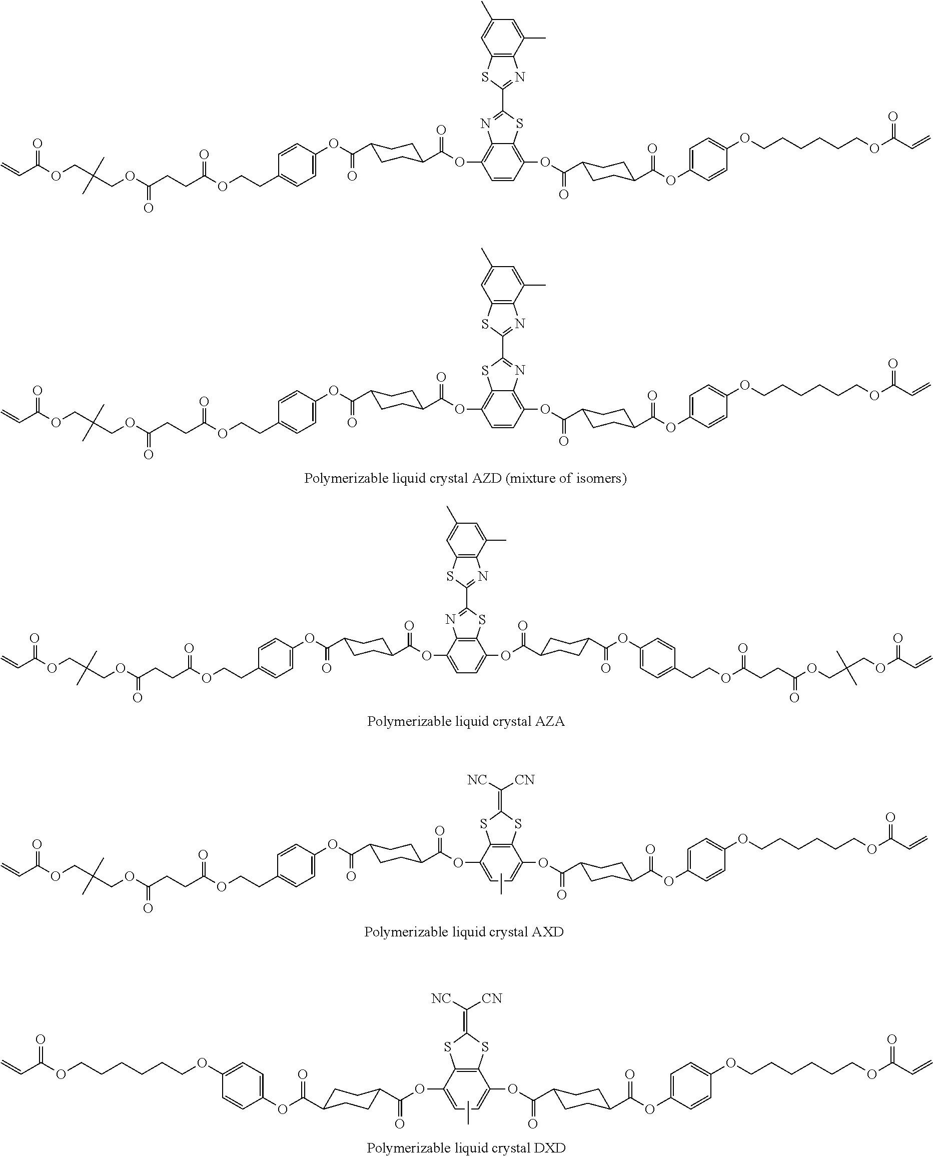

### Example 5

A reaction solution 5 having the following formulation was prepared, heated to 60° C., uniformly dissolved, and then cooled to 50° C.

Reaction solution 5

| | | |
|---|---|---|
| Polymerizable liquid crystal BYB shown above | 56.8 | parts by mass |
| Polymerizable liquid crystal CYC shown above | 43.2 | parts by mass |
| Cyclopentanone | 300 | parts by mass |

0.48 parts by mass of DIPEA was added to the cyclopentanone solution cooled to 50° C., and the mixture was stirred at 50° C. for 3 hours.

Next, 8.7 parts by mass of KYOWAAD 700SEN-S(manufactured by Kyowa Chemical Industry Co., Ltd.) was added to the reaction solution, and the mixture was stirred for 3 hours while the temperature was lowered to room temperature.

Next, after filtering KYOWAAD 700SEN-S, the same amount of KYOWAAD 700SEN-S was added to the filtrate, and the mixture was filtered to obtain a cyclopentanone solution of the polymerizable liquid crystal composition 3. Cyclopentanone was used as a washing solution during the filtration, and the concentration of solid contents was adjusted to 20 wt %. The compositional ratio of the polymerizable liquid crystal composition 5 was confirmed by HPLC, and it was confirmed that the compositional ratio was the following ratio.

Area percentage of polymerizable liquid
crystal composition 5 by HPLC

P1: polymerizable liquid crystal BYB shown above 41.2%
P2: polymerizable liquid crystal BYC shown below 27.5%
P3: polymerizable liquid crystal CYC shown above 31.3%

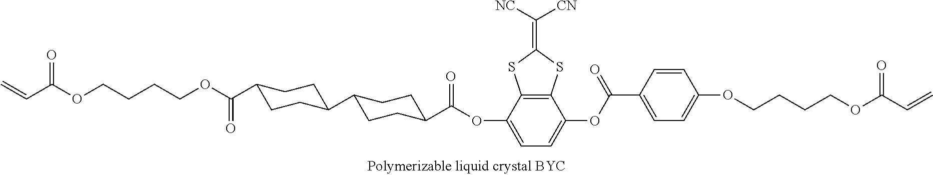 [SMILES: C=CC(=O)OCCCCOC(=O)C1CCC(C2CCC(C(=O)Oc3ccc(OC(=O)c4ccc(OCCCCOC(=O)C=C)cc4)c4c3SC(=C(C#N)C#N)S4)CC2)CC1]

### <Preparation of Coating Liquid for Forming Optically Anisotropic Film>

### Example 6

Using the polymerizable liquid crystal composition 1 prepared in Example 1, a coating liquid 1 for forming an optically anisotropic film, having the following formulation, was prepared.

Coating liquid 1 for forming optically anisotropic film

| | | |
|---|---|---|
| Polymerizable liquid crystal | 153.0 | parts by mass |
| composition 1 shown above | | |
| Polymerizable liquid crystal AXA shown above | 6.7 | parts by mass |
| Polymerizable liquid crystal BYB shown above | 16.5 | parts by mass |
| Polymerizable liquid crystal 7 shown below | 20.0 | parts by mass |
| Polymerizable liquid crystal 8 shown below | 16.5 | parts by mass |
| Polymerizable liquid crystal 9 shown below | 16.5 | parts by mass |
| Polymerizable liquid crystal 10 shown below | 15.0 | parts by mass |
| Polymerizable compound M1 shown below | 3.0 | parts by mass |
| Polymerization initiator S1 shown below | 1.5 | parts by mass |
| Leveling agent P1 shown below | 0.1 | parts by mass |
| Cyclopentanone | 92.5 | parts by mass |
| Methyl ethyl ketone | 64.2 | parts by mass |

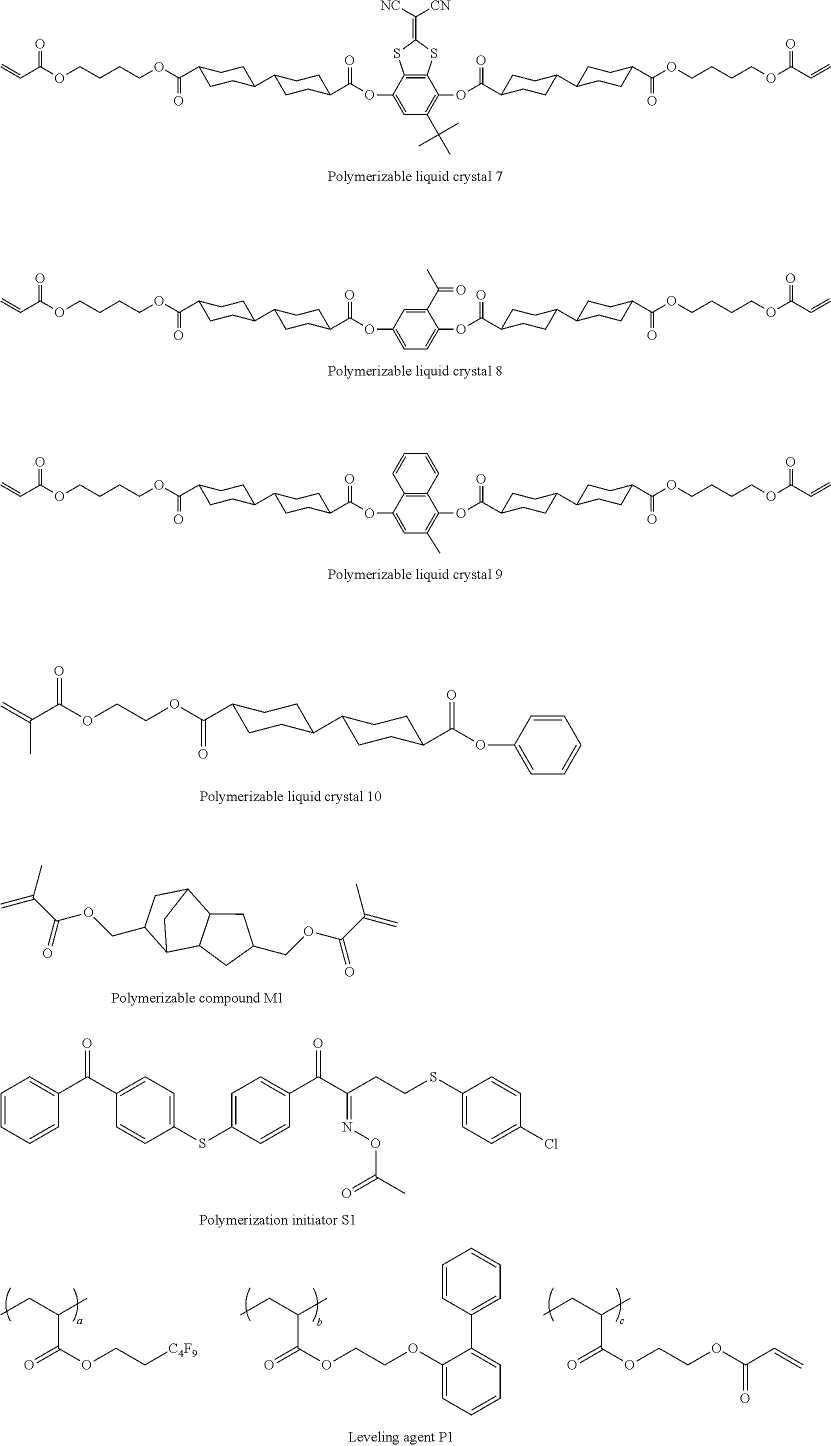

a, b, and c in the leveling agent P1 each indicate the content (% by mass) of each repeating unit with respect to all repeating units, and a=44.8, b=50.3, and c=4.9.

In addition, each area percentage of P1 to P6 contained in the coating liquid 1 for forming an optically anisotropic film was confirmed by HPLC, and it was confirmed that the following values were obtained.

Area percentage of coating liquid 1 for forming
optically anisotropic film by HPLC

P1: polymerizable liquid crystal AXA shown above 37.3%
P2: polymerizable liquid crystal AXB shown above 6.7%
P3: polymerizable liquid crystal BXB shown above 0.1%
P4: polymerizable liquid crystal BYB shown above 50.3%
P5: polymerizable liquid crystal AYB shown above 5.2%
P6: polymerizable liquid crystal AYA shown above 0.4%

### Example 7

A coating liquid 2 for forming an optically anisotropic film, having the following formulation, was prepared using the polymerizable liquid crystal composition 2 prepared in Example 2, instead of the polymerizable liquid crystal composition 1 contained in the coating liquid 1 for forming an optically anisotropic film.

Coating liquid 2 for forming optically anisotropic film

| | | |
|---|---|---|
| Polymerizable liquid crystal | 101.3 | parts by mass |
| composition 2 shown above | | |
| Polymerizable liquid crystal AXA shown above | 21.3 | parts by mass |
| Polymerizable liquid crystal BYB shown above | 15.4 | parts by mass |
| Polymerizable liquid crystal 7 shown above | 20.0 | parts by mass |
| Polymerizable liquid crystal 8 shown above | 16.5 | parts by mass |
| Polymerizable liquid crystal 9 shown above | 16.5 | parts by mass |
| Polymerizable liquid crystal 10 shown above | 15.0 | parts by mass |
| Polymerizable compound M1 shown above | 3.0 | parts by mass |
| Polymerization initiator S1 shown above | 1.5 | parts by mass |
| Leveling agent P1 shown above | 0.1 | parts by mass |
| Cyclopentanone | 133.9 | parts by mass |
| Methyl ethyl ketone | 64.2 | parts by mass |

In addition, each area percentage of P1 to P6 contained in the coating liquid 2 for forming an optically anisotropic film was confirmed by HPLC, and it was confirmed that the following values were obtained.

Area percentage of coating liquid 2 for forming
optically anisotropic film by HPLC

P1: polymerizable liquid crystal AXA shown above 47.3%
P2: polymerizable liquid crystal AXB shown above 9.0%
P3: polymerizable liquid crystal BXB shown above 0.5%
P4: polymerizable liquid crystal BYB shown above 35.0%
P5: polymerizable liquid crystal AYB shown above 6.9%
P6: polymerizable liquid crystal AYA shown above 1.3%

### Example 8

A coating liquid 3 for forming an optically anisotropic film, having the following formulation, was prepared using the polymerizable liquid crystal composition 3 prepared in Example 3, instead of the polymerizable liquid crystal composition 1 contained in the coating liquid 1 for forming an optically anisotropic film.

Coating liquid 3 for forming optically anisotropic film

| | | |
|---|---|---|
| Polymerizable liquid crystal | 101.2 | parts by mass |
| composition 3 shown above | | |
| Polymerizable liquid crystal AXA shown above | 24.5 | parts by mass |
| Polymerizable liquid crystal CYC shown above | 9.0 | parts by mass |
| Polymerizable liquid crystal 7 shown above | 20.0 | parts by mass |
| Polymerizable liquid crystal 8 shown above | 16.5 | parts by mass |
| Polymerizable liquid crystal 9 shown above | 16.5 | parts by mass |
| Polymerizable liquid crystal 10 shown above | 15.0 | parts by mass |
| Polymerizable compound M1 shown above | 3.0 | parts by mass |
| Polymerization initiator S1 shown above | 1.5 | parts by mass |
| Leveling agent P1 shown above | 0.1 | parts by mass |
| Cyclopentanone | 133.9 | parts by mass |
| Methyl ethyl ketone | 64.2 | parts by mass |

In addition, each area percentage of P1 to P6 contained in the coating liquid 3 for forming an optically anisotropic film was confirmed by HPLC, and it was confirmed that the following values were obtained.

Area percentage of coating liquid 3 for forming
optically anisotropic film by HPLC

P1: polymerizable liquid crystal AXA shown above 50.3%
P2: polymerizable liquid crystal AXC shown above 5.4%
P3: polymerizable liquid crystal CXC shown above 0.1%
P4: polymerizable liquid crystal CYC shown above 37.2%
P5: polymerizable liquid crystal AYC shown above 6.9%
P6: polymerizable liquid crystal AYA shown above 0.1%

### Example 9

A coating liquid 4 for forming an optically anisotropic film, having the following formulation, was prepared using the polymerizable liquid crystal composition 4 prepared in Example 4, instead of the polymerizable liquid crystal composition 1 contained in the coating liquid 1 for forming an optically anisotropic film.

Coating liquid 4 for forming optically anisotropic film

| | | |
|---|---|---|
| Polymerizable liquid crystal | 170.3 | parts by mass |
| composition 4 shown above | | |
| Polymerizable liquid crystal AXA shown above | 6.1 | parts by mass |
| Polymerizable liquid crystal DZD shown above | 9.1 | parts by mass |
| Polymerizable liquid crystal 7 shown above | 10.0 | parts by mass |
| Polymerizable liquid crystal 8 shown above | 16.5 | parts by mass |
| Polymerizable liquid crystal 9 shown above | 16.5 | parts by mass |
| Polymerizable liquid crystal 10 shown above | 15.0 | parts by mass |
| Polymerizable compound M1 shown above | 3.0 | parts by mass |
| Polymerization initiator S1 shown above | 1.5 | parts by mass |
| Leveling agent P1 shown above | 0.1 | parts by mass |
| Cyclopentanone | 78.7 | parts by mass |
| Methyl ethyl ketone | 64.2 | parts by mass |

In addition, each area percentage of P1 to P6 contained in the coating liquid 4 for forming an optically anisotropic film was confirmed by HPLC, and it was confirmed that the following values were obtained.

Area percentage of coating liquid 4 for forming
optically anisotropic film by HPLC

P1: polymerizable liquid crystal DZD shown above 60.9%
P2: polymerizable liquid crystal AZD shown above 2.4%
P3: polymerizable liquid crystal AZA shown above 0.0%
P4: polymerizable liquid crystal AXA shown above 35.0%
P5: polymerizable liquid crystal AXD shown above 1.7%
P6: polymerizable liquid crystal DXD shown above 0.0%

### Comparative Example 1

A comparative coating liquid H1 for forming an optically anisotropic film, having the following formulation, was prepared without using the polymerizable liquid crystal composition 1 contained in the coating liquid 1 for forming an optically anisotropic film.

Coating liquid H1 for forming optically anisotropic film

| | | |
|---|---|---|
| Polymerizable liquid crystal AXA shown above | 20.0 | parts by mass |
| Polymerizable liquid crystal BYB shown above | 27.0 | parts by mass |
| Polymerizable liquid crystal 7 shown above | 20.0 | parts by mass |
| Polymerizable liquid crystal 8 shown above | 16.5 | parts by mass |
| Polymerizable liquid crystal 9 shown above | 16.5 | parts by mass |
| Polymerizable liquid crystal 10 shown above | 15.0 | parts by mass |
| Polymerizable compound M1 shown above | 3.0 | parts by mass |
| Polymerization initiator S1 shown above | 1.5 | parts by mass |
| Leveling agent P1 shown above | 0.1 | parts by mass |
| Cyclopentanone | 214.9 | parts by mass |
| Methyl ethyl ketone | 64.2 | parts by mass |

### <Production of Optically Anisotropic Film>

### Example 10

A glass substrate provided with a rubbing-treated polyimide alignment film (SE-150 manufactured by Nissan Chemical Corporation) was coated with the coating liquid 1 for forming an optically anisotropic film, prepared in Example 6, by spin coating. The coating film was subjected to an alignment treatment at 200° C. to form a liquid crystal layer. Thereafter, the liquid crystal layer was cooled to 135° C. and subjected to alignment fixation by irradiation with ultraviolet rays at 1,000 mJ/cm² to form an optically anisotropic film, thereby obtaining an optical film 1 for measuring a wavelength dispersion.

The phase difference of the optical film 1 was measured, and it was confirmed that Re(450)/Re(550)=0.88.

### Example 11

An optical film 2 was obtained in the same manner as in Example 10, except that the coating liquid 2 for forming an optically anisotropic film was used instead of the coating liquid 1 for forming an optically anisotropic film.

The phase difference of the optical film 2 was measured, and it was confirmed that Re(450)/Re(550)=0.88.

### Example 12

An optical film 3 was obtained in the same manner as in Example 10, except that the coating liquid 3 for forming an optically anisotropic film was used instead of the coating liquid 1 for forming an optically anisotropic film.

The phase difference of the optical film 3 was measured, and it was confirmed that Re(450)/Re(550)=0.90.

### Example 13

An optical film 4 was obtained in the same manner as in Example 10, except that the coating liquid 4 for forming an optically anisotropic film was used instead of the coating liquid 1 for forming an optically anisotropic film.

The phase difference of the optical film 4 was measured, and it was confirmed that Re(450)/Re(550)=0.89.

### Evaluation of Precipitation

20 μL of each of the above-described polymerizable liquid crystal compositions 1 to 4 and the above-described coating liquids 1 to 4 and H1 for forming an optically anisotropic film was dropped onto a glass plate, and the state of precipitation of the solid film was visually observed after being allowed to stand at 25° C. for 1 hour. Specifically, the area of the white turbid portion (whitened portion) was estimated with respect to the area of the solid film, and precipitation was determined by an indicator of 1 to 3 according to the following determination criterion.

### <Precipitation Indicator>

Precipitation 1: whitening in a portion of 75% or more and 100% or less
Precipitation 2: whitening in a portion of 25% or more and less than 75%
Precipitation 3: whitening in a portion of 0% or more and less than 25%

### <Evaluation Result of Precipitation>

Example 1 (polymerizable liquid crystal composition 1): precipitation 3
Example 2 (polymerizable liquid crystal composition 2): precipitation 3
Example 3 (polymerizable liquid crystal composition 3): precipitation 3
Example 4 (polymerizable liquid crystal composition 4): precipitation 3
Example 6 (coating liquid 1 for forming optically anisotropic film): precipitation 3
Example 7 (Coating liquid 2 for forming optically anisotropic film): precipitation 3
Example 8 (coating liquid 3 for forming optically anisotropic film): precipitation 3
Example 9 (coating liquid 4 for forming optically anisotropic film): precipitation 3
Comparative Example 1 (coating liquid H1 for forming optically anisotropic film): precipitation 1

From the above results, it was found that the polymerizable liquid crystal composition containing the polymerizable liquid crystal compounds P1, P2, P4, and P5 and the coating liquid for forming an optically anisotropic film, which was contained the polymerizable liquid crystal composition, had excellent solubility and low precipitation from a solution.

### EXPLANATION OF REFERENCES

10: optical film
12: optically anisotropic film
14: alignment film
16: support

What is claimed is:

1. A polymerizable liquid crystal composition comprising:
polymerizable liquid crystal compounds P1, P2, P4, and P5 respectively represented by Formulae (1), (2), (4), and (5), 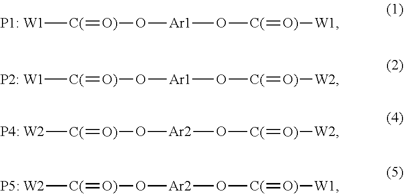
in Formulae (1), (2), (4), and (5),
W1's represent a monovalent group represented by Formula (7), each of which has the same ClogP value, and W2's represent a monovalent group represented by Formula (8), each of which has the same ClogP value, where the ClogP value of W1's is different from the ClogP value of W2's, and
Ar1's represent a divalent aromatic ring, each of which has the same ClogP value, Ar2's represent a divalent aromatic ring, each of which has the same ClogP value, and at least one of Ar1 or Ar2 represents any aromatic ring selected from the group consisting of groups represented by Formulae (Ar-1) to (Ar-7), where the ClogP value of Ar1's is larger than the ClogP value of Ar2's, 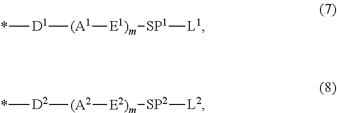
in Formulae (7) and (8),
* represents a bonding position to C(═O),
m and n each independently represent an integer of 1 or more,
D¹, D², E¹, and E² each independently represent a single bond, —CO—, —O—, —S—, —C(═S)—, —CR¹R²—, —CR³=CR⁴—, —NR—, or a divalent linking group consisting of a combination of two or more of these groups, where R¹ to R⁵ each independently represent a hydrogen atom, a fluorine atom, or an alkyl group having 1 to 4 carbon atoms, in a case where m is an integer of 2 or more, a plurality of E¹'s may be the same or different from each other, and in a case where n is an integer of 2 or more, a plurality of E²'s may be the same or different from each other,
A¹ and A² each independently represent an aromatic ring having 6 or more carbon atoms, which may have a substituent, or a cycloalkane ring having 6 or more carbon atoms, which may have a substituent, in a case where m is an integer of 2 or more, a plurality of A¹'s may be the same or different from each other, and in a case where n is an integer of 2 or more, a plurality of A²'s may be the same or different from each other,
SP¹ and SP² each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent, and
L¹ and L² each independently represent a monovalent organic group, where at least one of L¹ or L² represents a polymerizable group, provided that, in a case where Ar1 or Ar2 in Formulae (1), (2), (4), and (5) is an aromatic ring represented by Formula (Ar-3), at least one of L¹ or L², or L³ or L⁴ in Formula (Ar-3) represents a polymerizable group, 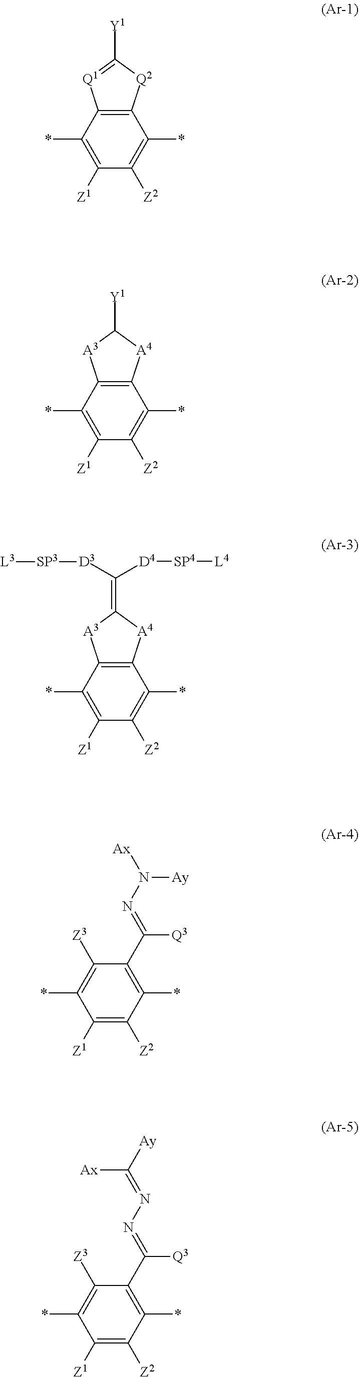 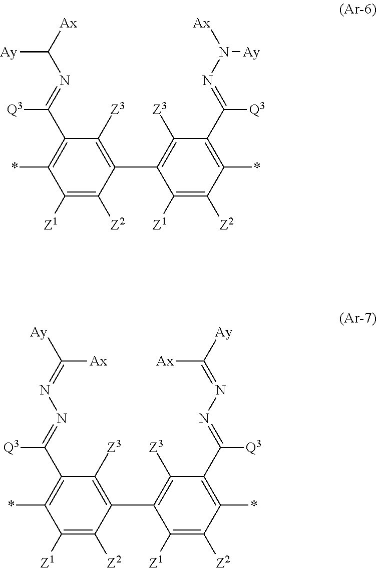
in Formulae (Ar-1) to (Ar-7),
* represents a bonding position to an oxygen atom,
Q¹ represents N or CH,
Q² represents —S—, —O—, or —N(R⁶)—, where R⁶ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, each of which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁷, —NR⁸R⁹, or —SR¹⁰, where R⁷ to R¹⁰ each independently represent a hydrogen atom or and an alkyl group having 1 to 6 carbon atoms, and Z¹ and Z² may be bonded to each other to form an aromatic ring,
A³ and A⁴ each independently represent a group selected from the group consisting of —O—, —N(R¹¹)—, —S—, and —CO—, where R¹¹ represents a hydrogen atom or a substituent,
X represents a non-metal atom of Groups 14 to 16, provided that a hydrogen atom or a substituent may be bonded to the non-metal atom,
D³ and D⁴ each independently represent a single bond, —CO—, —O—, —S—, —C(═S)—, —CR¹R²—, —CR³=CR⁴—, —NR⁵—, or a divalent linking group consisting of a combination of two or more of these groups, where R¹ to R⁵ each independently represent a hydrogen atom, a fluorine atom, or an alkyl group having 1 to 4 carbon atoms,
SP³ and SP⁴ each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent,
L³ and L⁴ each independently represent a monovalent organic group, where at least one of L³ or L⁴, or L¹ or L² represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
where the aromatic rings in Ax and Ay may have a substituent, and Ax and Ay may be bonded to each other to form a ring, and
Q³ represents a hydrogen atom or an alkyl group having 1 to 6 carbon atoms, which may have a substituent.

2. The polymerizable liquid crystal composition according to claim 1, further comprising:
polymerizable liquid crystal compounds P3 and P6 respectively represented by Formulae (3) and (6), 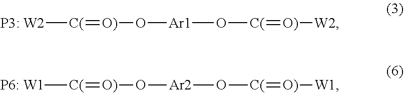
W1, W2, Ar1, and Ar2 in Formulae (3) and (6) are the same as those groups described in Formulae (1), (2), (4), and (5), respectively.

3. The polymerizable liquid crystal composition according to claim 2,
wherein, in a case where area percentages of the polymerizable liquid crystal compounds P1 to P6 are measured at a measurement wavelength of 254 nm with a high-performance liquid chromatograph, a larger one of the area percentages of the polymerizable liquid crystal compounds P1 and P3 is defined as C1 and a smaller one thereof is defined as C3, a larger one of the area percentages of the polymerizable liquid crystal compounds P4 and P6 is defined as C4 and a smaller one thereof is defined as C6, and the area percentages of the polymerizable liquid crystal compounds P2 and P5 are each defined as C2 and C5, the following expressions (A), (B), (C), (D), and (E) are satisfied,

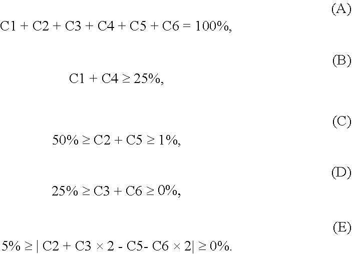

4. The polymerizable liquid crystal composition according to claim 1,
wherein the polymerizable liquid crystal composition has smectic liquid crystallinity.

5. An optically anisotropic film obtained by fixing an alignment state of the polymerizable liquid crystal composition according to claim 1.

6. The optically anisotropic film according to claim 5,
wherein the following expression (F) is satisfied, 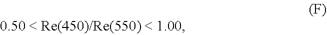
in the expression (F), Re(450) represents an in-plane retardation of the optically anisotropic film at a wavelength of 450 nm, and Re(550) represents an in-plane retardation of the optically anisotropic film at a wavelength of 550 nm.

7. An optical film comprising:
the optically anisotropic film according to claim 5.

8. A polarizing plate comprising:
the optical film according to claim 7; and
a polarizer.

9. An image display apparatus comprising:
the optical film according to claim 7.

10. A method for producing a polymerizable liquid crystal composition, comprising:
dissolving polymerizable liquid crystal compounds P1 and P3 respectively represented by Formulae (1) and (3) in a solvent and performing a reaction to obtain a polymerizable liquid crystal composition containing polymerizable liquid crystal compounds P1 to P3 respectively represented by Formulae (1) to (3) and the solvent, 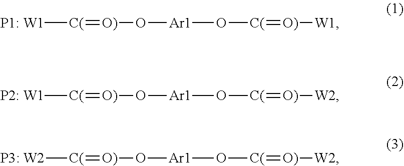
in Formulae (1) to (3),
W1's represent a monovalent group represented by Formula (7), each of which has the same ClogP value, and W2's represent a monovalent group represented by Formula (8), each of which has the same ClogP value,
where the ClogP value of W1's is different from the ClogP value of W2's, and
Ar1's represent a divalent aromatic ring, each of which has the same ClogP value, and represent any aromatic ring selected from the group consisting of groups represented by Formulae (Ar-1) to (Ar-7), 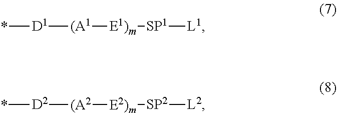
in Formulae (7) and (8),
* represents a bonding position to C(═O),
m and n each independently represent an integer of 1 or more,
D¹, D², E¹, and E² each independently represent a single bond, —CO—, —O—, —S—, —C(═S)—, —CR¹R²—, —CR³=CR⁴—, —NR—, or a divalent linking group consisting of a combination of two or more of these groups, where R¹ to R⁵ each independently represent a hydrogen atom, a fluorine atom, or an alkyl group having 1 to 4 carbon atoms, in a case where m is an integer of 2 or more, a plurality of E¹'s may be the same or different from each other, and in a case where n is an integer of 2 or more, a plurality of E²'s may be the same or different from each other,
A¹ and A² each independently represent an aromatic ring having 6 or more carbon atoms, which may have a substituent, or a cycloalkane ring having 6 or more carbon atoms, which may have a substituent, in a case where m is an integer of 2 or more, a plurality of A¹'s may be the same or different from each other, and in a case where n is an integer of 2 or more, a plurality of A²'s may be the same or different from each other,
SP¹ and SP² each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent, and
L¹ and L² each independently represent a monovalent organic group, where at least one of L¹ or L² represents a polymerizable group, provided that, in a case where Ar1 in Formulae (1) to (3) is an aromatic ring represented by Formula (Ar-3), at least one of L¹ or L², or L³ or L⁴ in Formula (Ar-3) represents a polymerizable group, 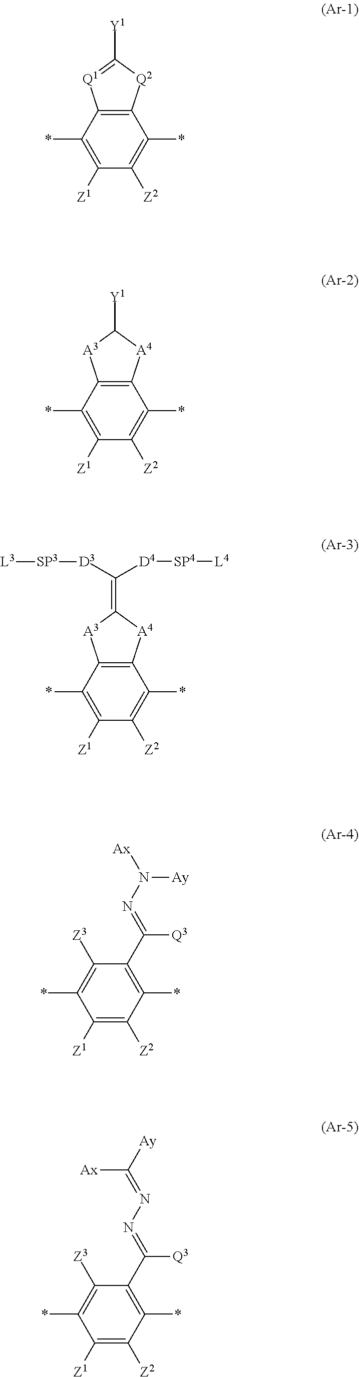 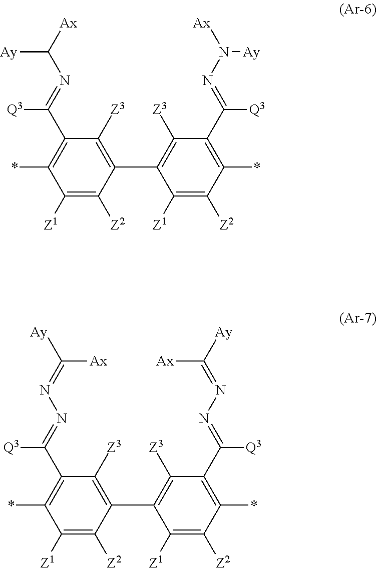
in Formulae (Ar-1) to (Ar-7),
* represents a bonding position to an oxygen atom,
Q¹ represents N or CH,
Q² represents —S—, —O—, or —N(R⁶)—, where R⁶ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, each of which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁷, —NR⁸R⁹, or —SR¹⁰, where R⁷ to R¹⁰ each independently represent a hydrogen atom or and an alkyl group having 1 to 6 carbon atoms, and Z¹ and Z² may be bonded to each other to form an aromatic ring,
A³ and A⁴ each independently represent a group selected from the group consisting of —O—, —N(R¹¹)—, —S—, and —CO—, where R¹¹ represents a hydrogen atom or a substituent,
X represents a non-metal atom of Groups 14 to 16, provided that a hydrogen atom or a substituent may be bonded to the non-metal atom,
D³ and D⁴ each independently represent a single bond, —CO—, —O—, —S—, —C(═S)—, —CR¹R²—, —CR³=CR⁴—, —NR⁵—, or a divalent linking group consisting of a combination of two or more of these groups, where R¹ to R⁵ each independently represent a hydrogen atom, a fluorine atom, or an alkyl group having 1 to 4 carbon atoms,
SP³ and SP⁴ each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent,
L³ and L⁴ each independently represent a monovalent organic group, where at least one of L³ or L⁴, or L¹ or L² represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
where the aromatic rings in Ax and Ay may have a substituent, and Ax and Ay may be bonded to each other to form a ring, and
Q³ represents a hydrogen atom or an alkyl group having 1 to 6 carbon atoms, which may have a substituent.

11. A method for producing a polymerizable liquid crystal composition, comprising:
dissolving polymerizable liquid crystal compounds P1 and P4 respectively represented by Formulae (1) and (4) in a solvent and performing a reaction to obtain a polymerizable liquid crystal composition containing polymerizable liquid crystal compounds P1, P2, P4, and P5 respectively represented by Formulae (1), (2), (4), and (5) and the solvent, 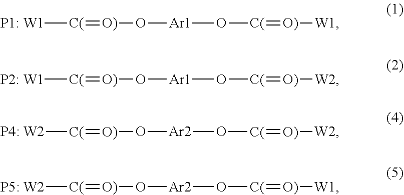
in Formulae (1), (2), (4), and (5),
W1's represent a monovalent group represented by Formula (7), each of which has the same ClogP value, and W2's represent a monovalent group represented by Formula (8), each of which has the same ClogP value,
where the ClogP value of W1's is different from the ClogP value of W2's, and
Ar1's represent a divalent aromatic ring, each of which has the same ClogP value, Ar2's represent a divalent aromatic ring, each of which has the same ClogP value, and at least one of Ar1 or Ar2 represents any aromatic ring selected from the group consisting of groups represented by Formulae (Ar-1) to (Ar-7), where the ClogP value of Ar1's is larger than the ClogP value of Ar2's, 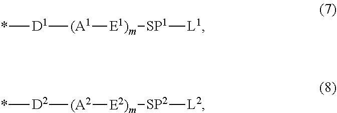
in Formulae (7) and (8),
* represents a bonding position to C(═O),
m and n each independently represent an integer of 1 or more,
D¹, D², E¹, and E² each independently represent a single bond, —CO—, —O—, —S—, —C(═S)—, —CR¹R²—, —CR³=CR⁴—, —NR—, or a divalent linking group consisting of a combination of two or more of these groups, where R¹ to R⁵ each independently represent a hydrogen atom, a fluorine atom, or an alkyl group having 1 to 4 carbon atoms, in a case where m is an integer of 2 or more, a plurality of E¹'s may be the same or different from each other, and in a case where n is an integer of 2 or more, a plurality of E²'s may be the same or different from each other,
A¹ and A² each independently represent an aromatic ring having 6 or more carbon atoms, which may have a substituent, or a cycloalkane ring having 6 or more carbon atoms, which may have a substituent, in a case where m is an integer of 2 or more, a plurality of A¹'s may be the same or different from each other, and in a case where n is an integer of 2 or more, a plurality of A²'s may be the same or different from each other,
SP¹ and SP² each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent, and
L¹ and L² each independently represent a monovalent organic group, where at least one of L¹ or L² represents a polymerizable group, provided that, in a case where Ar1 or Ar2 in Formulae (1), (2), (4), and (5) is an aromatic ring represented by Formula (Ar-3), at least one of L¹ or L², or L³ or L⁴ in Formula (Ar-3) represents a polymerizable group, 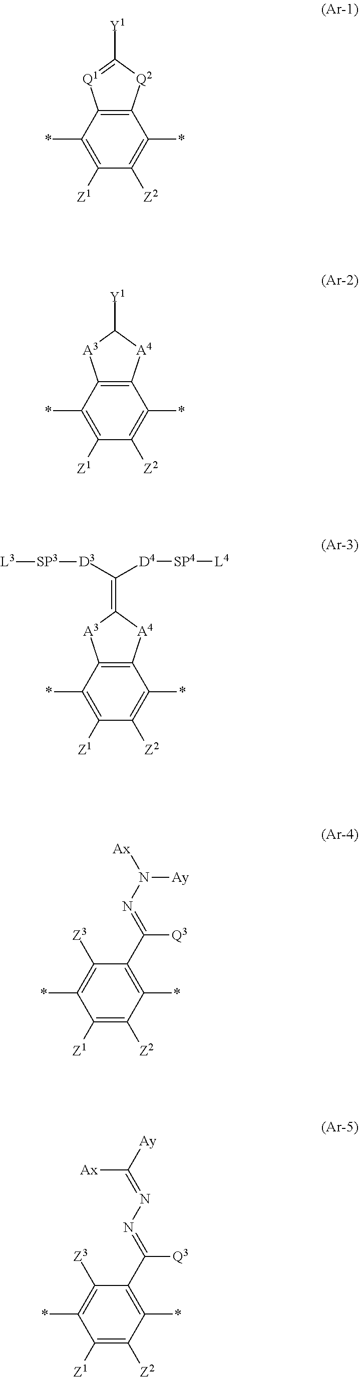 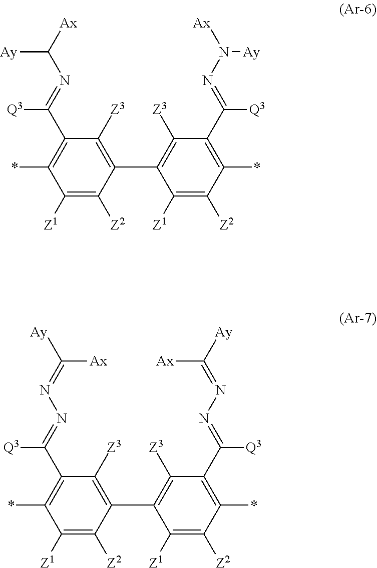
in Formulae (Ar-1) to (Ar-7),
* represents a bonding position to an oxygen atom,
Q¹ represents N or CH,
Q² represents —S—, —O—, or —N(R⁶)—, where R⁶ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, each of which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁷, —NR⁸R⁹, or —SR¹⁰, where R⁷ to R¹⁰ each independently represent a hydrogen atom or and an alkyl group having 1 to 6 carbon atoms, and Z¹ and Z² may be bonded to each other to form an aromatic ring,
A³ and A⁴ each independently represent a group selected from the group consisting of —O—, —N(R¹¹)—, —S—, and —CO—, where R¹¹ represents a hydrogen atom or a substituent,
X represents a non-metal atom of Groups 14 to 16, provided that a hydrogen atom or a substituent may be bonded to the non-metal atom,
D³ and D⁴ each independently represent a single bond, —CO—, —O—, —S—, —C(═S)—, —CR¹R²—, —CR³=CR⁴—, —NR⁵—, or a divalent linking group consisting of a combination of two or more of these groups, where R¹ to R⁵ each independently represent a hydrogen atom, a fluorine atom, or an alkyl group having 1 to 4 carbon atoms,
SP³ and SP⁴ each independently represent a single bond, an alkylene group having 1 to 20 carbon atoms, an alkenylene group having 2 to 20 carbon atoms, an alkynylene group having 2 to 20 carbon atoms, or a divalent linking group in which one or more of —CH₂-'s constituting the alkylene group, the alkenylene group, and the alkynylene group are substituted with —O—, —S—, —NH—, —N(Q)-, or —CO—, where Q represents a substituent,
L³ and L⁴ each independently represent a monovalent organic group, where at least one of L³ or L⁴, or L¹ or L² represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
where the aromatic rings in Ax and Ay may have a substituent, and Ax and Ay may be bonded to each other to form a ring, and
Q³ represents a hydrogen atom or an alkyl group having 1 to 6 carbon atoms, which may have a substituent.

12. The method for producing a polymerizable liquid crystal composition according to claim 11,
wherein the polymerizable liquid crystal composition further contains polymerizable liquid crystal compounds P3 and P6 respectively represented by Formulae (3) and (6), 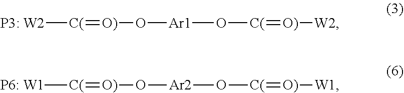
W1, W2, Ar1, and Ar2 in Formulae (3) and (6) are the same as those groups described in Formulae (1), (2), (4), and (5), respectively.

13. The method for producing a polymerizable liquid crystal composition according to claim 10,
wherein a basic compound is added before the reaction.

14. The method for producing a polymerizable liquid crystal composition according to claim 13,
wherein the basic compound is removed after the reaction.

15. The polymerizable liquid crystal composition according to claim 2,
wherein the polymerizable liquid crystal composition has smectic liquid crystallinity.

16. An optically anisotropic film obtained by fixing an alignment state of the polymerizable liquid crystal composition according to claim 2.

17. The optically anisotropic film according to claim 16,
wherein the following expression (F) is satisfied, 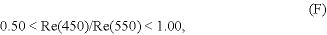
in the expression (F), Re(450) represents an in-plane retardation of the optically anisotropic film at a wavelength of 450 nm, and Re(550) represents an in-plane retardation of the optically anisotropic film at a wavelength of 550 nm.

18. An optical film comprising:
the optically anisotropic film according to claim 6.

19. A polarizing plate comprising:
the optical film according to claim 18; and
a polarizer.

20. An image display apparatus comprising:
the polarizing plate according to claim 8.
